(19) United States
(12) Patent Application Publication
(10) Pub. No.: US 2024/0214859 A1
(43) Pub. Date: Jun. 27, 2024

(54) COMMUNICATION SYSTEM

(71) Applicant: NEC Corporation, Minato-ku, Tokyo (JP)

(72) Inventors: Yuhua CHEN, Tokyo (JP); Neeraj GUPTA, Tokyo (JP)

(73) Assignee: NEC Corporation, Minato-ku, Tokyo (JP)

(21) Appl. No.: 18/288,476

(22) PCT Filed: Apr. 27, 2022
(86) PCT No.: PCT/JP2022/019164

§ 371 Date: Oct. 26, 2023

(30) Foreign Application Priority Data
May 7, 2021 (GB) 2106571.9

(51) Int. Cl. H04W 28/02; H04W 64/00

(52) U.S. Cl. CPC H04W 28/0226; H04W 64/006

(57) ABSTRACT

A method performed by a first network entity including RAN equipment (5) in a communication system is disclosed. The method includes obtaining information relating to a mobility state of a UE (3), determining a mobility specific configuration for the UE (3) based on the mobility state, and providing configuration information for configuring the UE (3) with the mobility specific configuration.

### TECHNICAL FIELD

The present disclosure relates to a communication system. The present disclosure has particular but not exclusive relevance to wireless communication systems and devices thereof operating according to the 3rd Generation Partnership Project (3GPP) standards or equivalents or derivatives thereof (including LTE-Advanced and Next Generation or 5G networks). The present disclosure has particular, although not necessarily exclusive relevance to, improved apparatus and methods that support a variety of different low mobility or (near) stationary user equipments (UEs).

### BACKGROUND ART

Recent developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 (NPL 1). 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the base station (or ‘radio access network (RAN) node’) via which communication devices (referred to as user equipments or ‘UEs’) connect to a core network and communicate with other communication devices or remote servers. For simplicity, the present application will use the term base station, RAN node or simply, or simply ‘RAN’ to refer to any such equipment or equivalent apparatus for providing access to the network.

In the current 5G architecture, for example, the gNB structure may be split into two or more parts. In some RAN implementations there are two parts, known as the Central Unit (CU or gNB-CU)—sometimes referred to as a ‘control unit’- and the Distributed Unit (DU or gNB-DU), connected by an F1 interface. This enables the use of a ‘split’ architecture in which the typically ‘higher’ CU layers (for example, but not necessarily or exclusively, Packet Data Convergence Protocol (PDCP) and Radio Resource Control (RRC) layers) and the, ‘lower’ DU layers (for example, but not necessarily or exclusively, Radio Link Control (RLC), Media Access Control (MAC), and Physical (PHY) layers) are separated between a particular CU, and one or more DUs that are connected to and controlled by that CU via the F1 interface. Thus, for example, the higher layer CU functionality for a number of gNBs may be implemented centrally (for example, by a single processing unit, or in a cloud-based or virtualised system), whilst retaining the lower layer DU functionality locally separately for each gNB.

In more recently proposed RAN distributed architectures the, in addition to the CU and DU, the concept of a Radio Unit (RU)—sometimes referred to as a ‘remote unit’—has been introduced. In this architecture the RU is responsible for handling the digital front end (DFE), digital beamforming functionality and, typically, the functionality of the lower parts of the PHY layer, whilst the DU typically handles the higher parts of the PHY layer and the RLC and MAC layers. The CU in this architecture continues to be responsible for controlling one or more DUs (each DU corresponding to a different respective gNB) and to handle higher layer signalling (typically RRC and PDCP layers).

The actual functional split between the CU and DUs (and potentially RUS where applicable) of these distributed architectures is flexible allowing the functionality to be optimised for different use cases. Effectively, the split architecture enables a 5G network to use a different distribution of protocol stacks between CU and DUs (and potentially RUs) depending on, for example, midhaul availability and network design.

The choice of how to split functions in the architecture depends on, among other things, factors related to radio network deployment scenarios, constraints and intended supported use cases. Key considerations include: the need to support a specific quality of service for each service offered and for real/non-real time applications; support of specific user density and load demand in a given geographical area; and available transport networks with different performance levels.

In efforts to move away from vendor specific deployments, towards deployments in which hardware and software components from different vendors are interoperable and can be mixed and matched, there has been a drive to so-called ‘open’ interfaces between the various elements of the RAN. In earlier generations the RAN incorporated controllers that were responsible for RAN orchestration and management. With the development of 4G, the overall network architecture became flatter and the expectation was that, to enable optimal subscriber experience, base stations would use the standardised base station to base station (X2) interface to communicate with each other to handle resource allocation. However, whilst the X2 application protocol was largely standardised, different RAN vendors still produced their own variations of the X2 interface thus making it difficult for a mobile network operator (MNO) to use equipment from more than one RAN vendor in a particular location. More recently there has been a movement back towards the controller concept to allow disaggregation of hardware and software and development of open interfaces between them. This movement is known as ‘Open RAN’ and whilst it has particular relevance for 5G and future generations it is also applicable to RAN development for earlier generations.

In the context of 5G, in which many 5G scenarios require low latency, implementation of 5G concepts such as Control and User Plane Separation (CUPS), functional RAN splits and network slicing, require a combination of advanced RAN virtualization and software defined networking (SDN). This has led to the concept of a RAN Intelligent Controller (RIC) being developed as part of the Open RAN movement. The RIC comprises a Non-Real-Time (non-RT) RIC (supporting tasks that require >1s latency) and a Near-Real Time RIC (latency of <1s).

The Near-RT RIC is responsible for per-UE controlled load-balancing, RB management, interference detection and mitigation. To facilitate this, the Near-RT RIC provides cloud-based infrastructure for controlling a distributed collection of RAN nodes (eNB, gNB, CU, DU) in a particular geographic area via an open “southbound” interface (E2) protocol. The Near-RT RIC also provides open “northbound” interfaces (A1 and O1), to a service management and orchestration (SMO) framework, for operators. The Near-RT RIC hosts micro-service-based applications called xApps that are run by the Near-RT RIC and that can use the E2 interface to collect near real-time information (on a UE basis or a cell basis). These xApps cover functions such as mobility management, admission control, and interference management. The Near-RT RIC also enforces network policies via the E2 interface toward the radios and provides advanced control functionalities with the intention of increasing efficiency and providing improved radio resource management (RRM). These control functionalities make use of analytics and data-driven approaches including advanced machine learning (ML)/artificial intelligence (AI) tools to improve resource management capabilities. The Near-RT RIC's control over the E2 nodes (e.g. eNB, gNB, CU, DU or the like) is steered via the policies and the data provided via the A1 interface from the Non-RT RIC. The RRM functional allocation between the Near-RT RIC and the E2 node is subject to the capability of the E2 node and is controlled by the Near-RT RIC. For example, the near-RT RIC may monitor, suspend/stop, override or control the node via Non-RT RIC enabled policies. The Near-RT RIC may be deployed in a number of ways for example as a virtual network function (VNF), a set of virtual machines (VMs), or as a cloud native function (CNF).

The Non-RT RIC forms part of the SMO framework and connects to the Near-RT RIC for the management and optimization of the RAN. Network management applications in the Non-RT RIC receive and act on data from the DU and CU provided in a standardised format over the A1 Interface. Non-RT RIC functionality includes configuration management, device management, fault management, performance management, and lifecycle management for all network elements in the network. All new RUs are self-configured by the Non-RT RIC, reducing the need for manual intervention. The provision by the Non-RT RIC of insights into network operations, allows MNOs to better understand and, as a result, better optimize the network by applying pre-determined service and policy parameters. The Non-RT RIC supports intelligent RAN optimisation by providing policy-based guidance, model management and enrichment information to the Near-RT RIC so that the RAN can be optimised efficiently and effectively. The Non-RT RIC can use data analytics and machine learning (ML)/artificial intelligence (AI) training/inference to identify appropriate RAN optimisation actions for which it can use SMO services.

The separation of functionalities on southbound and northbound interfaces enables more efficient and cost-effective radio resource management for real-time and non-real-time functionalities, as the RIC customizes network optimization for each network environment and use case.

For simplicity, the present application will use the term mobile device, user device, or UE to refer to any communication device that is able to connect to the core network via one or more base stations (with a split/distributed architecture or otherwise). Although the present application may refer to ‘mobile’ devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

Whilst UEs in the form of traditional cell phones are still the dominant device type in market, the 3GPP is working towards the goal of “connecting everything everywhere” as communication technology evolves to 5G and future generations.

This is leading to an increase in both the variety of device types and in the relative proportion of all connected devices that such device types make up. Such device types may include, for example, devices that take advantages of specific advances in communication technology such as advances related to: Ultra Reliable Low Latency Communication (ULLC); Device-to-Device (D2D) communication and related technologies (e.g. Vehicle-to-Vehicle (V2V), Vehicle-to-Everything (V2X), and Vehicle-to-Infrastructure (V2I)); Integrated Access Backhaul (IAB); Internet of Things (IOT) related technologies such as NarrowBand-Internet of Things (NB-IOT) and Industrial Internet of Things (IIoT); Virtual Reality (VR), Extended Reality (XR) and Augmented Reality (AR) applications; and Non-Terrestrial Network (NTN) technologies.

Many fundamental features designed with conventional cellular mobile phones in mind are complicated, are not strictly necessary for all devices especially for (quasi) stationary devices such as smart meters, Fixed Wireless Access (FWA) or the like, and can therefore represent an undesirable and unnecessary cost. Even though dedicated configurations are available for low mobility UEs, the RAN equipment (e.g. gNB) needs to have knowledge of the UE mobility to configure the RAN equipment and/or UE appropriately. To avoid inadvertent use of inappropriate configurations being used, a cautious configuration approach is generally taken and, as a result, a conservative configuration is often used.

Examples of procedures that may use configurations to which the UE's mobility state is relevant include:
Paging—e.g. configuration of the paging area or tracking area (TA) size to be a small or a big TA;
Periodic or regular Tracking Area Updates (TAU) and/or Routing Area Updates (RAU)—e.g. configuration at the UE of the TAU or RAU periodicity to be a short or a longer periodicity;
Handover—e.g. the measurement configuration for low mobility UEs compared to higher mobility UEs;
Timing advance maintenance—e.g. the configuration of the Time Alignment Timer (TAT) anywhere from a short TAT up to an infinite TAT;
Channel adaptive scheduling—e.g. configuration of reporting of buffer status reports (BSRs) and/or power headroom reports (PHRs) at the UE; and/or
Power control—e.g. configuration to enable or to disable open loop power control (OLPC) and/or closed loop power control (CLPC).

Currently, two different types of mobility information are specified.

The first type of mobility information (mobility information #1) essentially defines three mobility states—normal, medium and high—based on the number of cell reselections during a configured time period relative to two parameters. The two parameters comprise N_{CR_M}, which specifies the maximum number of cell reselections to enter the medium mobility state, and N_{CR_H}, which specifies the maximum number of cell reselections to enter the high mobility state. If the number of cell reselections during a time period of specified duration for evaluating allowed amount of at least one cell reselection (T_{CRmax}) is less than N_{CR_M} then the UE is determined to be in the normal mobility state. If the number of cell reselections in this period is greater than or equal to N_{CR_M} but less than or equal to N_{CR_H} then the UE is determined to be in the medium mobility state. If the number of cell reselections in this period is greater than N_{CR_H} then the UE is determined to be in the mobility state. The determined mobility state is used for the speed dependent scaling of a cell reselection parameter. Effectively, these specified mobility states are defined for the benefit of ensuring faster cell reselection for faster moving (i.e. medium/high) UEs.

The second type of mobility information (mobility information #2) comprises a mobility history report (in the form of a mobility HistoryReport Information Element (IE)) comprising a visited cell information list (in the form of a VisitedCellInfoList IE) that includes mobility history information for a maximum of 16 most recently visited cells, and/or information identifying time spent in any cell selection state and/or camped on any cell state in NR or E-UTRA. The most recently visited cell is stored first in the list. The list includes cells visited in the idle, inactive or connected states (RRC_IDLE, RRC_INACTIVE and RRC_CONNECTED) for NR, and idle or connected states (RRC_IDLE and RRC_CONNECTED) for E-UTRA. This information is reported to the network, on request, via a request/response procedure (e.g. a UE Information Request from the RAN equipment and an associated UE Information Response message from the UE).

### CITATION LIST

### Non Patent Literature

NPL 1: ‘NGMN 5G White Paper’ V1.0, the Next Generation Mobile Networks (NGMN) Alliance, February 2015, https://www.ngmn.org/wp-content/uploads/NGMN_5 G_White_Paper_V1_0.pdf

### SUMMARY OF INVENTION

### Technical Problem

The first and second specified mobility information described above oriented to traditional cell-phone type devices that will typically exhibit at least some movement. However, using such mobility information to provide addition configuration flexibility has a number of issues. Firstly, for example, there can be significant delay associated with the long observation time window necessary to acquire the information required to optimize certain high-level parameters such as, for example, paging/tracking area. Secondly, such configuration assumes a certain level of UE capability which may mismatch with the actual UE's abilities (especially in the case of low cost, reduced capability UEs that are often used in (quasi) stationary scenarios). For example, acquisition of the mobility information assumes the UE has an ability to store the required information and an associated reporting capability, which may not be available for lower end devices such as smart meters or the like. Thirdly, the information has a relatively high, cell-level, granularity.

There has been some recent discussion on a mechanism for low UE mobility detection based on measurements of reference signal received power (RSRP) and/or reference signal received quality (RSRQ). Specifically, the network can configure a UE with RSRP/RSRQ-based low-mobility criteria (e.g. threshold based) that can be used to detect a low mobility UE state. Where a UE is determined to have a low mobility, the UE is allowed to perform relaxed RRM measurement for intra/inter frequency cells. There has also been discussion of whether further RRM measurement relaxation can be applied for neighbouring cells for a “stationary” UE although it is not yet clear what would be considered to constitute a “stationary” UE as the definition is still under discussion. One option is to define stationary UEs is based on the low-mobility criteria but using different thresholds specifically configured for identifying stationary UEs.

Another option is to use a “stationary” property in the UE's subscription information although it has not been agreed that such a property should be included in the UE's subscription.

Whilst low mobility or stationary device detection based on corresponding low mobility or stationary RSRP/RSRQ based criteria allows for some configuration flexibility it is used only for RRM measurement relaxing and is not available for use by the network for other optimisation tasks. Moreover, it is not clear how a stationary property (even if it is introduced to the UE's subscription information) can be initialised and updated in the UE subscription information.

There is, therefore, a need for an approach that supports greater flexibility to adaptively configure devices such as user equipment and RAN equipment in an optimum manner based on the mobility characteristics of that device.

The present disclosure aims to provide improved apparatus and methods which addresses or at least partially ameliorate one or more of the above issues, or that at least partially contribute to meeting the above need.

### Solution to Problem

In one example described herein there is disclosed a method performed by a first network entity in a communication system, the method comprising: obtaining information relating to a mobility state of a user equipment (UE); determining a mobility specific configuration for the UE based on the mobility state; and providing configuration information for configuring the UE with the mobility specific configuration.

The method may further comprising: performing a verification of the information relating to the mobility state of the UE before determining the mobility specific configuration, wherein the determining is performed in a case where the verification is successful. The verification may be performed based on a comparison of, a predicted location and/or predicted movement of the UE with location information and/or measurement data for that UE collected from that UE. The verification may be performed based on a comparison of the information relating to the mobility state of the UE with another information relating to a mobility state of the UE generated by the first network entity or another network entity.

The information relating to the mobility state of the UE may include information identifying a current and/or predicted mobility state for the UE, and the determining may be performed based on the current and/or predicted mobility state for the UE. The information relating to the mobility state of the UE may include an indication for indicating whether or not the UE is stationary or near-stationary, and/or an indication for indicating one of a plurality of mobility categories into which movement of the UE has been categorised. The information relating to the mobility state of the UE may include an indication for indicating a mobility related configuration preference. The information relating to the mobility state of the UE may be included in at least one of: a radio resource control (RRC) message; a UE Assistance Information Message; a media access control (MAC) control element (CE) message; and a Non-Access Stratum (NAS) message. The mobility specific configuration for the UE may include one of, or a combination of, the following: a mobility specific measurement configuration; a mobility specific power control (PC) configuration; a mobility specific power headroom reporting (PHR) configuration; a mobility specific time alignment timer (TAT) configuration; and/or a mobility specific paging area/tracking area configuration. The providing the configuration information may be performed using one of: a radio resource control (RRC) signalling; and an RRC reconfiguration message. The information relating to the mobility state of the UE may be included in a UE profile.

The obtaining may include receiving, from a second network entity, the information relating to the mobility state of the UE, and the providing may include providing the configuration information, to the UE or to a third network entity. The obtaining may include receiving, from the UE, the information relating to the mobility state of the UE, and the providing may include providing the configuration information, to the UE or to a second network entity.

The second network entity may include at least one of: a radio access network (RAN) intelligent controller (RIC) entity, a non-real time RIC; and a near-real time RIC. The second network entity may include at least one of: a core network control plane function, a unified data management (UDM) function; and a home subscriber server (HSS). The second network entity may comprise an Operations, Administration and Maintenance (OAM) function.

The first network entity may include at least one of: a radio access network (RAN) equipment, a central unit (CU) of a base station, a distributed unit (DU) of a base station, and an integrated base station. The first network entity may include at least one of: a radio access network (RAN) intelligent controller (RIC) entity, a near-real time RIC; and a non-real time RIC. The first network entity may include at least one of: a core network control plane function, and a session management function (SMF).

In one example described herein there is disclosed a method performed by a user equipment (UE) in a communication system, the method comprising: providing, to a network entity, information relating to a mobility state of the UE to support determining a mobility specific configuration for the UE.

The method may further comprise receiving, from the network entity or another network entity, configuration information for configuring the UE with the mobility specific configuration. The information relating to the mobility state of the UE may include information identifying a device type of the UE corresponding to the mobility status of the UE. The information relating to the mobility state of the UE may include information identifying a location of the UE. The information relating to the mobility state of the UE may include any one of, or combination of, the following: information identifying a time at, or time period within, which the UE is expected to be stationary; information identifying a location in which the UE is expected to be stationary; information identifying a time at, or time period within, which the UE is expected to be moving; information identifying a location to which, or from which, the UE is expected to be moving; information identifying a geographic area within which movement of the UE is expected to be confined; and/or information identifying a reliability of information in the information relating to the mobility state of the UE. The information relating to the mobility state of the UE may include information identifying a reliability of information in the information relating to the mobility state of the UE, and the determining is performed based on the reliability.

In one example described herein there is provided a computer program product comprising instructions which, when the program is executed by a computer apparatus, cause the computer to carry out the steps of one of the above methods.

In one example described herein there is disclosed a first network entity for a communication system, the first network entity comprising: means for obtaining information relating to a mobility state of a user equipment (UE); means for determining a mobility specific configuration for the UE based on the mobility state; and means for providing configuration information for configuring the UE with the mobility specific configuration.

In one example described herein there is disclosed a user equipment (UE) for a communication system, the UE comprising: means for providing, to a network entity, information relating to a mobility state of the UE to support determining a mobility specific configuration for the UE.

Aspects of the present disclosure are set out in the appended independent claims. Optional but beneficial features are set out in the appended dependent claims. Aspects of the present disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the present disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the present disclosure will now be described, by way of example, with reference to the accompanying drawings in which:

FIG. 1 schematically illustrates a mobile (‘cellular’ or ‘wireless’) telecommunication system;

FIG. 2 is a simplified schematic block diagram illustrating the main components of a user equipment for the telecommunication system shown in FIG. 1;

FIG. 3 is a simplified schematic block diagram illustrating the main components of a radio unit of RAN equipment for the telecommunication system shown in FIG. 1;

FIG. 4 is a simplified schematic block diagram illustrating the main components of a distributed unit of RAN equipment for the telecommunication system shown in FIG. 1;

FIG. 5 is a simplified schematic block diagram illustrating the main components of a central unit of RAN equipment for the telecommunication system shown in FIG. 1;

FIG. 6 is a simplified schematic block diagram illustrating the main components of a an integrated gNB for the telecommunication system shown in FIG. 1;

FIG. 7 is a simplified schematic block diagram illustrating the main components of a near-real time RAN intelligent controller for the telecommunication system shown in FIG. 1;

FIG. 8 is a simplified schematic block diagram illustrating the main components of a non-real time RAN intelligent for the telecommunication system shown in FIG. 1;

FIG. 9 is a simplified schematic block diagram illustrating the main components of a network node for the telecommunication system shown in FIG. 1;

FIG. 10 is a simplified timing diagram illustrating two possible procedures for providing a UE with a mobility specific configuration in the communication system of FIG. 1;

FIG. 11 is a simplified timing diagram illustrating another possible procedure for providing a UE with a mobility specific configuration in the communication system of FIG. 1;

FIG. 12 is a simplified timing diagram illustrating two further possible procedures for providing a UE with a mobility specific configuration in the communication system of FIG. 1;

FIG. 13 is a simplified timing diagram illustrating two further possible procedures for providing a UE with a mobility specific configuration in the communication system of FIG. 1;

FIG. 14 is a simplified timing diagram illustrating other possible procedures for providing a mobility specific configuration for a UE in the communication system of FIG. 1;

FIG. 15 is a simplified timing diagram illustrating another possible procedures for providing a UE with a mobility specific configuration in the communication system of FIG. 1; and

FIG. 16 is a simplified timing diagram illustrating another possible procedures for providing a UE with a mobility specific configuration in the communication system of FIG. 1.

### DESCRIPTION OF EMBODIMENTS

### Overview

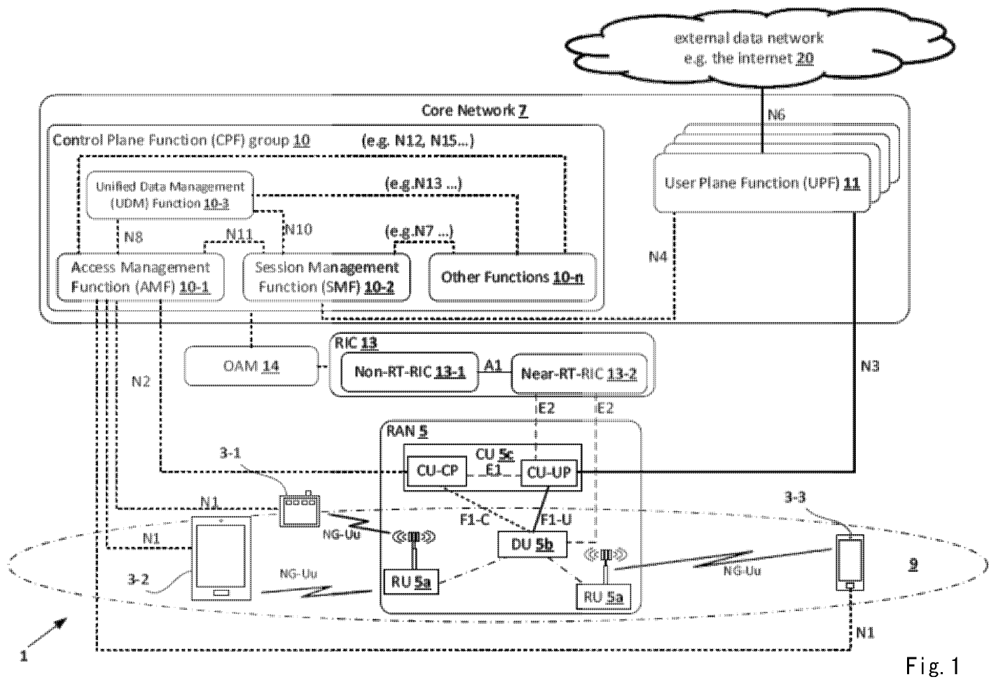

An exemplary communication system will now be described, by way of example only, with reference to FIG. 1.

FIG. 1 schematically illustrates a mobile (‘cellular’ or ‘wireless’) communication system 1 to which embodiments of the present disclosure are applicable.

In the communication system 1 user equipment (UEs) 3-1, 3-2, 3-3 (e.g. mobile telephones and/or other mobile devices) can communicate with each other via radio access network (RAN) equipment 5 that operates according to one or more compatible radio access technologies (RATs). In the illustrated example, the RAN equipment 5 comprises a distributed NR/5G base station or ‘gNB’ operating one or more associated cells 9. Communication via the base station 5 is typically routed through a core network 7 (e.g. a 5G core network or evolved packet core network (EPC)).

As those skilled in the art will appreciate, whilst three UEs 3 and one RAN equipment 5 are shown in FIG. 1 for illustration purposes, the system, when implemented, will typically include other RAN equipment and UEs.

Each RAN equipment 5 controls the at least one associated cell either directly, or indirectly via one or more other nodes (such as home base stations, relays, remote radio heads, distributed units, and/or the like). It will be appreciated that the RAN equipment 5 may be configured to support both 4G and 5G, and/or any other 3GPP or non-3GPP communication protocols.

In this example the illustrated RAN equipment 5 comprises a distributed base station comprising a plurality of radio units (RUS) 5a, a distributed unit (DU) 5b, and a central unit (CU) 5c. The CU 5c employs a separated control plane and user plane and so is, itself, split between a control plane function (CU-CP) and a user plane function (CU-UP) which respectively communicate, with the DU via an F1-C logical interface and an F1-U logical interface (together forming an F1 interface (or ‘reference point’)), and with one another via an E1 logical interface.

The illustrated RAN equipment 5 is controlled by a RAN intelligent controller (RIC) 13 comprising a non-real time RIC (non-RT-RIC) 13-1 and a near-real time RIC (near-RT-RIC) 13-2 that communicate with one another via an A1 interface. The near-real time RIC 13-2 supports tasks that require short (<1s) latencies while the non-real time RIC 13-1 supports tasks that can be performed with a longer latency (<1s). The near-RT RIC 13-2 is responsible for per-UE controlled load-balancing, resource (resource block (RB)) management, interference detection and mitigation. The non-RT RIC 13-1 forms part of a service management and orchestration (SMO) layer and communicates with the near-RT RIC 13-2, via the A1 interface, for the management and optimization of the RAN equipment 5.

It will be appreciated that whilst distributed RAN equipment 5 is shown and described, the RAN equipment 5 may be provided in a non-distributed form, for example as an integrated gNB or eNB.

The UEs 3 and their serving RAN equipment 5 are connected via an appropriate air interface (for example the so-called ‘Uu’ interface and/or the like). Equipment of neighbouring RANs 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises a number of control plane functions (CPFs) 10 and one or more user plane functions (UPFs) 11. The CPFs 10 include one or more Access and Mobility Management Functions (AMFs) 10-1, one or more Session Management Functions (SMFs) 10-2, one or more unified data management (UDM) functions 10-3, and a number of other functions 10-n (such as, for example an Authentication Server Function (AUSF) which facilitates 5G security processes).

The communication system also includes an Operations, Administration and Maintenance (OAM) system 14 comprising one or more OAM functions for provisioning and managing network or elements within the wider communication system 1. The OAM 14 may be responsible for the storage and analysis of some radio-related measurements and may perform some data analytics functions including some RAN analytics.

The RAN equipment 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the RAN equipment 5.

The at least one UPF 11 is connected to an external data network (e.g. an IP network such as the internet) 20 via reference point N6 for communication of the user data.

The AMF 10-1 performs mobility management related functions, maintains the non-NAS signalling connection with each UE 3 and manages UE registration. The AMF 10-1 receives user information sent through the network and forwards the information to the SMF 10-2. The AMF 10-1 is also responsible for managing paging.

The SMF 10-2 provides session management functionality (that formed part of MME functionality in LTE) and additionally combines some control plane functions (provided by the serving gateway and packet data network gateway in LTE). The SMF 10-2 uses user information provided via the AMF 10-1 to determine what session manager would be best assigned to the user. The SMF 10-2 may be considered effectively to be a gateway from the user plane to the control plane of the network. The SMF 10-2 also allocates IP addresses to each UE 3.

The UDM function 10-3 manages network user data in a single, centralised, element. For example, the UDM 10-3 manages data for access authorization, user registration, and data network profiles, and provides subscriber data to the SMF. The UDM function 10-3 is typically provided as a cloud-native function and is typically paired with one or more user data repositories (UDRs) which store user data such as customer profile information, customer authentication information, and encryption keys for the information. Effectively, user information is stored in the UDR, and the UDM function 10-3 retrieves the data, sends it to other network functions, and generally manages it. The UDM function 10-3 uses microservices to communicate between the user plane and the control plane.

### UE (‘Mobility’) Profile

Beneficially, the communication system 1 employs a dedicated, UE specific, mobility related UE profile, that can be used to readily identify a mobility state of the UE 3 to which the UE profile relates. The UE profile may, for example, comprise a mobility profile that explicitly identifies whether the UE 3 is a fixed device, a low mobility device, a high mobility device or the like. The UE profile may include information relating to a mobility state of the UE. Alternatively or additionally, the UE profile (for example, the information relating to a mobility state of the UE) may comprise a device profile that explicitly identify a device type of the UE 3 (e.g. that the device is an internet-of-things (IOT) device, a fixed wireless access (FWA) device or the like. The device type is a device type of the UE corresponding to the mobility status of the UE.). The UE profile may be referred to generally as a ‘Mobility Profile’ or as a ‘Device Profile’.

In some examples described in more detail later, the UE profile is built up by, or preconfigured in (e.g. hard written into) the memory of, the UE 3. In some examples described in more detail later, the UE profile is built up by, or preconfigured in (e.g. hard written into) the memory of, a higher level (core) network entity such as the near-RT RIC 13-2, non-RT RIC 13-1, UDM 10-3, or OAM 14, and/or of integrated RAN equipment. It will be appreciated that whilst these different possibilities are described as different examples later, they are not mutually exclusive, and both the UE 3 and one or more network entities may be able to build up the UE profile (or different elements of it).

As indicated above, the information forming the UE profile may be preconfigured in (e.g. hard written into) the memory of the UE 3 and/or network entity. This preconfigured information may form all, or only part of, the information forming the UE profile. The preconfigured information could, for example, explicitly identify the UE 3 as being a ‘mounted’ or ‘stationary’ device. Where information is built up at the UE 3 or in a network entity it may use artificial intelligence (AI)/machine learning (ML) based tools to build up the profile based on predictions of mobility based on other forms of data.

These AI/ML tools may, for example, may comprise a trained artificial neural network or other similar AI model or tool, that receives one or more inputs of information originating from the UE 3 (or derived from such information) and generates, from these inputs, at least one output for forming the UE (‘mobility’) profile (or information for forming such a profile).

For example, possible inputs include: positioning information (e.g. Global Positioning System (GPS) information, or other information representing a location of the UE (e.g. serving cell identity and/or the like); information identifying one or more visited cells (e.g. an identifying a current visited cell and/or one or more historically visited cells); measurement results (e.g. RSRP and/or RSRQ associated with the serving cell and/or one or more neighbour cells); information representing a record of handovers (and or cell (re)selections); and/or a time and/or date in an appropriate format (e.g. Coordinated Universal Time (UTC)) associated with one or more of the other items of inputted information.

Possible outputs for forming the UE profile (e.g. the information relating to the mobility state of the UE) include, for example: information identifying a current and/or predicted mobility state or mobility category associated with the UE (e.g. whether the device is stationary, or moving within a small area, or moving in wide area, moving between known locations, and/or the like); if the UE is moving, whether the UE is moving with an identifiable pattern; information representing an identified (or predicted) pattern of movement for the UE (e.g. information identifying an expected location or area and/or expected mobility state or categories for different times of day and/or for different dates); and/or a confidence or reliability level associated with one or more of the other items of outputted information (e.g. information identifying a reliability of information in the information relating to the mobility state of the UE).

Beneficially the UE profile is, ultimately, shared with the RAN equipment (e.g. the gNB-CU and/or the gNB-DU) where it is used for simplifying the handling of the UE 3 (for example measurement configuration, power control (PC), power headroom reporting (PHR) configuration, time alignment timer (TAT) configuration, paging area/tracking area configurations etc.) where appropriate, based on the UE's mobility related characteristics. The UE's mobility related profile may be provided to the RAN equipment 5 in any suitable manner including as part of a RAN-UE request/response procedure and/or as part of radio resource control (RRC) signalling during an RRC connection establishment procedure.

The content of the UE profile may be relatively simple—for example comprising information that simply indicates that the UE 3 is a mounted device (and, therefore, has no mobility), optionally the UE profile can also include information identifying a location of the UE 3.

Nevertheless, the UE profile can be more comprehensive for example indicating when and where the UE 3 will be—or is very likely to be—stationary, when and where the UE 3 is—or is very likely to be—moving. Such information may be accompanied by a reliability indicator to indicate how reliable (or ‘permanent’) the profile, or that part of the profile, is. An example of part of such a profile is as follows:

| Time | Location | Mobility | Reliability |
|---|---|---|---|
| 8pm to 8am | @Home | Stationary | 90% |
| 8am to 9:30am | Travel from Home to Work | Mobile | 60% |
| 9:30am to 5:30pm | @Work | Stationary | 80% |
| 5:30pm to 8:00pm | Travel from Work to Home | Mobile | 70% |

The UE profile may also indicate that the UE 3, whilst mobile, is typically only mobile within the boundaries of a fixed area. For example, a UE 3 in the form of an item of medical equipment that is used in a hospital may have associated information, included in the corresponding UE profile, that identifies that the UE 3 is (typically) only used within the confines of a hospital. Similarly, a connected industrial UE used within a factory, warehouse or distribution centre may have associated information, included in the corresponding UE profile, that identifies that the UE 3 is (typically) only used within that industrial location. In another example, a connected educational device used in a school, college or university may have associated information, included in the corresponding UE profile, that identifies that the UE 3 is (typically) only used within that educational establishment's location.

### Network-Based UE Profile

In one example described in more detail later, the non-RT RIC 13-1 builds up the UE profile. This profile may be built up based on information from a number of sources including, for example, mobility information #1 (described in the introduction), measurement results provided in an RRC measurement report (or a plurality of such reports) by the UE 3, geographic location information provided by that UE 3 (e.g. as part of measurement logging by that UE 3), and/or other information.

The non-RT RIC 13-1 shares the UE profile to the most relevant near-RT RIC 13-2 via, for example, the A1 interface (although it will be appreciated that it may be shared directly to the RAN equipment—e.g. with the gNB, eNB, gNB-CU, and/or gNB-DU).

In more detail, during the RRC connection establishment phase, the near-RT RIC 13-2 may check the UE mobility profile provided by the non-RT RIC 13-1, and inform the RAN equipment 5 of the current mobility state and or a predicted future mobility state. The RAN equipment 5 may use the received information for configuring the UE 3 and/or communications with the UE 3 appropriately. For example, the RAN equipment 5 may determine a mobility specific configuration for the UE based on the mobility state included in the UE profile and provide configuration information for configuring the UE with the mobility specific configuration. The RAN equipment 5 may perform the determining based on the reliability of information in the information relating to the mobility state of the UE. The near-RT RIC 13-2 may (re)configure UE 3 itself, based on a mobility prediction via, for example, the E2 interface with the RAN equipment (gNB DU 5b, gNB CU 5c, or integrated gNB).

It will be appreciated that whilst this example is described in the context of a RIC 13 based solution to which the non-RT RIC 13-1 and near-RT RIC 13-2 may contribute, the UE profile may be built up and passed to the RAN equipment 5 by any suitable network entity including, for example, the UDM 10-3, the OAM 14 and/or the like. The near-RT RIC 13-2 may also build up the UE profile rather than the non-RT RIC 13-1 (where applicable).

RRC/MAC layer provision of UE Profile

In another example described in more detail later, the UE 3 builds up the UE profile. This profile may be built up based on information from a number of sources including, for example, mobility information #1 (described in the introduction), measurement results acquired by the UE 3, geographic location information acquired at the UE 3 (e.g. as part of measurement logging by that UE 3), and/or other information. This UE profile 3 (or relevant information from it) may be provided to the RAN equipment 5 upon connection setup and/or when upon a change in mobility state.

The UE profile 3 (or relevant information from it) may be provided using RRC or media access control (MAC) signalling (e.g. in a MAC control element (CE)). For example, information from the UE profile 3 may be provided, directly or indirectly, as initial (or updated) mobility assistance/preference information, to the RAN equipment 5 using an RRC message (e.g. a message like the RRC UE assistance information message), or a MAC CE. A direct indication may comprise, for example, a stationary indication indicating that the UE 3 is (quasi) stationary (e.g. a single bit set to ‘l’ to indicate the UE 3 is (quasi)stationary or ‘0’ to indicate that the UE is not (quasi) stationary (or vice versa)). A direct indication may also (or instead) comprise an indication of one of a plurality of mobility categories (e.g. (quasi)stationary, moving within a limited geographic area, moving between two specific points, random mobility, low mobility, medium mobility, high mobility or the like). An indirect indication may comprise, for example, a configuration preference that is relevant to mobility (e.g. a bigger/infinite TAT is preferred, relaxed radio resource management (RRM) measurement is preferred, no (or less) measurement configuration is preferred, no handover is preferred and so on).

Where the RAN equipment 5 employs a CU-DU split architecture in which the DU 5b is responsible for lower layers including the MAC layer and the CU 5c is responsible for higher layers including RRC, the gNB CU 5c may share the assistance/preference information with the DU 5b via the F1 interface when assistance/preference information is received by the CU 5c via an RRC message (such as the UE assistance message). Similarly, the gNB DU 5b may share the assistance/preference information with the CU 5c via the F1 interface when assistance/preference information is received by the DU 5b via a MAC CE message. The RAN equipment 5 (gNB CU 5c and/or gNB DU 5b) may use the received information to determine an appropriate configuration for the UE.

NAS/higher layer provision of UE Profile

In another example described in more detail later, as in the previous example, the UE3 builds up the UE profile. However, unlike the previous example, the UE reports/updates the profile to core network (e.g. via a non-access stratum (NAS) message or the like sent to the AMF 10-1 or equivalent control plane entity). This profile may then, optionally, be stored in the UDM 10-3 (or HSS where such an HSS is present in the core network). The UE profile is then, in this example, made available to the SMF 10-2 where it is used for the purposes of generating a mobility specific NAS configuration. For example, based on the UE profile the core network 7 may optimize the NAS configuration for a specific UE for prioritising where to page the UE first based on a prediction of where (e.g. a specific cell or optimised paging area) the UE is located. Such a prediction may identify a single location (cell or optimised paging area) or a list of such locations that is ordered in order of decreasing reliability (or confidence level). Similarly, the core network may adjust or optimise a registration area associated with the UE based on information derived from the UE profile.

When a UE context is being setup then, in this example, during the UE context setup phase, the UE profile (or a short term UE mobility state derived based on the UE profile) is made available to RAN equipment 5 for access stratum (AS) configuration. The AS configuration may, for example, configure the TAT (to be long or infinite) for the UE 3, disable power control for the UE 3, configure no measurement reporting/no handover for the UE 3 (only RRC connection release since no measurement report and handover actions can be performed).

Hybrid example—UE and Network involved in UE Profile generation

In another example described in more detail later, both the UE 3 and network (e.g. non-RT RIC, near-RT RIC, UDM, OAM or other network entity) are involved in UE profile generation and updating.

In one variation of this example, the network entity is involved in verifying a reported or updated UE profile that has been built up and reported by the UE 3 (e.g. using NAS/higher layer signaling as described for the previous example). This verification may, for example, be carried out by comparing, a predicted location and/or predicted movement of the UE 3 based on the UE profile reported by the UE 3, with live location information and/or measurement data for that UE 3 collected by network from that UE 3. The UE profile may then be used, as described in previous examples, subject to successful verification. Beneficially, this verification may be carried out in the OAM system, since the OAM function 14 will collect a lot of live network information, and can therefore confirm the UE's real location with the predicated location based on the UE profile (although it will be appreciated that such verification may take place elsewhere in the network).

In another variation of this example, both the network entity and the UE 3 are involved in building a UE profile for that UE 3 separately and in parallel with one another. The UE profile may then be used, as described in previous examples, subject to verification based on a comparison between the UE profiles generated by the UE 3 and network entity respectively indicating that there is a sufficient (predefined) level of similarity between the UE generated and network generated UE profile. The verification may be carried out by the network entity responsible for building the network originating UE profile in the case of verification by comparison (although it will be appreciated that such verification may take place elsewhere in the network).

### User Equipment

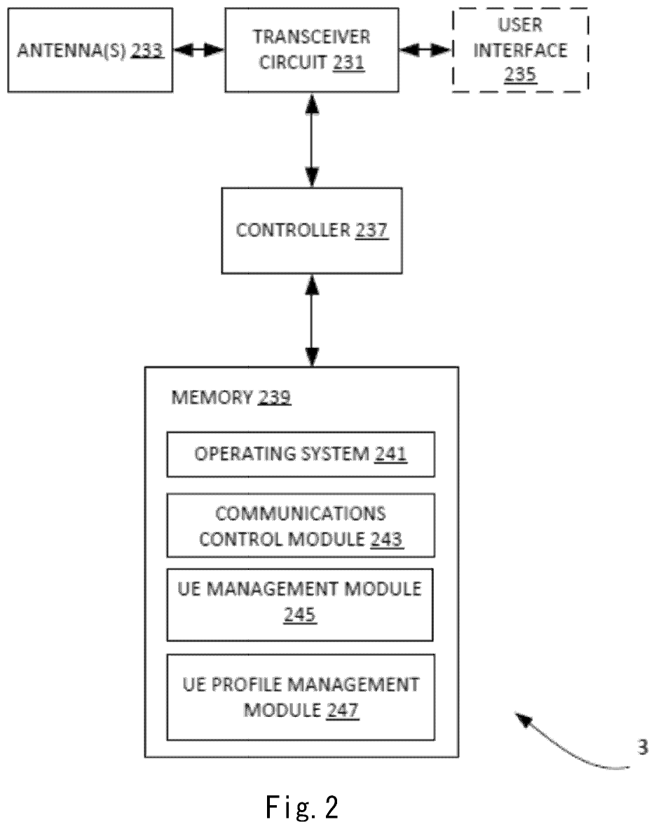

FIG. 2 is a schematic block diagram illustrating the main components of a UE 3 as shown in FIG. 1.

As shown, the UE 3 has a transceiver circuit 231 that is operable to transmit signals to and to receive signals from a RAN equipment 5 via one or more antenna 233. The UE 3 has a controller 237 to control the operation of the UE 3. The controller 237 is associated with a memory 239 and is coupled to the transceiver circuit 231. Although not necessarily required for its operation, the UE 3 might, of course, have all the usual functionality of a conventional UE 3 (e.g. a user interface 235, such as a touch screen/keypad/microphone/speaker and/or the like for, allowing direct control by and interaction with a user) and this may be provided by any one or any combination of hardware, software and firmware, as appropriate. Software may be pre-installed in the memory 239 and/or may be downloaded via the telecommunications network or from a removable data storage device (RMD) for example.

The controller 237 is configured to control overall operation of the UE 3 by, in this example, program instructions or software instructions stored within memory 239. As shown, these software instructions include, among other things, an operating system 241, a communications control module 243, a UE management module 245, and a UE profile management module 247.

The communications control module 243 is operable to control the communication between the UE 3 and its serving RAN equipment 5 (and other communication devices connected to the RAN equipment 5, such as further UEs and/or core network nodes). The communications control module 243 is configured for the overall handling uplink communications transmitted by the UE towards the network and for handling receipt of downlink communications from the network.

The UE management module 245 is responsible for managing the overall operation of the UE and the overall performance of the tasks required of the UE. These tasks include, among other things; the generation and transmission of appropriate messages using appropriate signalling application protocols such as (but not limited to) RRC signalling, MAC signalling, and NAS signalling; the performance of measurements (e.g. RSRP and/or RSRQ measurements); the generation of associated measurement reports for sending to the RAN equipment 5 if and when required; location acquisition and reporting; cell selection and reselection; monitoring the number of cell (re)selections to identify a mobility state (e.g. mobility information #1); compilation of visited cell information (e.g. mobility information #2); etc.

The UE profile management module 247 is responsible for carrying out functions related to the UE (mobility) profile including (where applicable): the building, updating, storage and maintenance of the UE profile; the extraction of appropriate assistance information from, or the generation of configuration preference information based on, the current UE profile stored in memory 239; and the provision of the assistance/preference information—and/or the UE profile itself—to the UE management module 245 for transmission, using appropriate signalling, to the RAN equipment 5, and/or to a core network or other network entity. It will be appreciated that, depending on implementation, the UE 3 may not implement at least some of these features. For example, if the UE 3 profile is only generated at the network side, then the UE profile management module 247 may be configured to provide any information required to support the profile generation in the network (e.g. by providing preconfigured mobility related information, about the mobility state of the UE 3 and/or the device type (e.g. IoT, FWA, mounted, etc.)).

### RAN Equipment (RU)

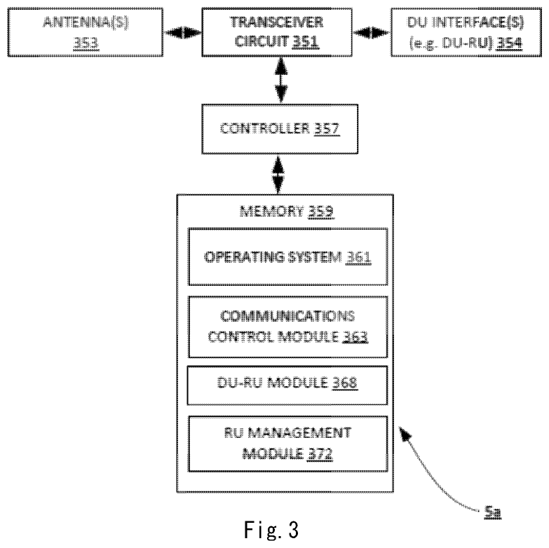

FIG. 3 is a schematic block diagram illustrating the main components of the RU 5a of the RAN equipment 5 for the communication system 1 shown in FIG. 1. As shown, the RU 5a has a transceiver circuit 351 for: transmitting signals to, and for receiving signals from, the communication devices (such as UEs 3) via one or more antenna 353 (e.g. an antenna array/massive antenna); and transmitting signals to, and for receiving signals from, the DU 5b of the RAN equipment 5 via a DU interface 354 (e.g. comprising the DU-RU interface or the like). The RU 5a has a controller 357 to control the operation of the RU 5a. The controller 357 is associated with a memory 359. Software may be pre-installed in the memory 359 and/or may be downloaded via the communications network 1 or from a removable data storage device (RMD) for example. The controller 357 is configured to control the overall operation of the RU Sa by, in this example, program instructions or software instructions stored within memory 359.

As shown, these software instructions include, among other things, an operating system 361, a communications control module 363, a DU-RU module 368, and an RU management module 372.

The communications control module 363 is operable to control the communication between the RU Sa and UEs 3, and between the RU 5a and the DU 5b. The communications control module 363 is configured for the overall control of the reception, at the physical layer level, of signals corresponding to uplink communications from the UE 3 and for handling, at the physical layer level, the transmission of downlink communications to the UE 3.

The DU-RU module 368 is responsible for the appropriate processing of signals received from, or transmitted to, the DU 5b via the at least one DU (e.g. DU-RU) interface 354.

The RU management module 372 is responsible for managing the overall operation of the RU Sa and the overall performance of the tasks required of the RU 5a.

It will be appreciated that whilst the RU Sa is not described as having any specific functionality related to the UE profile, the RU 5a will receive, process and forward, to the DU 5b, UE profile related signalling (e.g. carrying the UE profile and/or assistance/preference information extracted from or derived based on the UE profile to the DU 5b and carrying UE profile based configuration information from the DU 5b to the UE 3). It is also possible that the functional split between the RU Sa and DU 5b, could be such that the RU 5a performs some or all of the UE profile related operations described herein as being performed at the DU 5b. It will also be appreciated that the functions of the RU Sa may be integrated with those of the DU 5b in a more integrated DU 5b, or may be integrated with those of the DU 5b and of the CU 5c in a fully integrated gNB 5.

### RAN Equipment (DU)

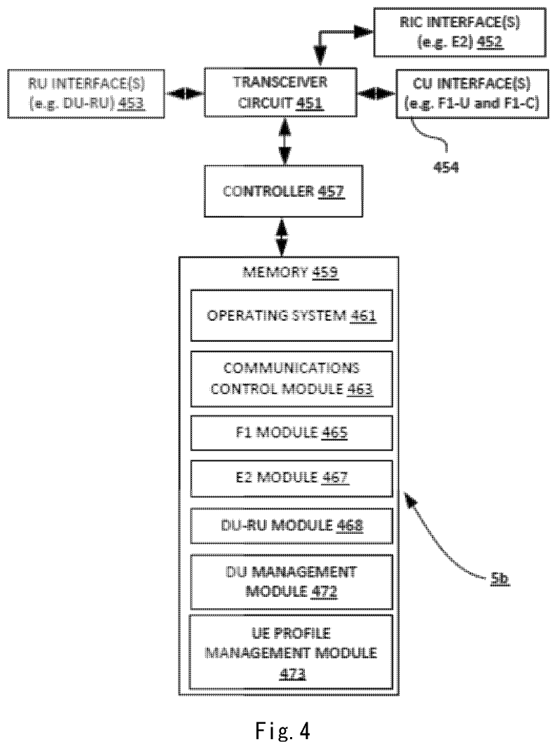

FIG. 4 is a schematic block diagram illustrating the main components of the DU 5b of the RAN equipment 5 for the communication system 1 shown in FIG. 1. As shown, the DU 5b has a transceiver circuit 451 for: transmitting signals to, and for receiving signals from, the communication devices (such as UEs 3) via the RU 5a and the associated DU-RU interface 453; for transmitting signals to, and for receiving signals from, the CU 5c of the RAN equipment 5 via a CU interface 454 (e.g. comprising an F1 interface which may be split into an F1-U and an F1-C interface for user plane and control plane signalling respectively); and for transmitting signals to, and for receiving signals from, the RIC 13 (and in particular the near-RT RIC 13-2) via a RIC interface 452 (e.g. comprising an E2 interface).

The DU 5b has a controller 457 to control the operation of the DU 5b. The controller 457 is associated with a memory 459. Software may be pre-installed in the memory 459 and/or may be downloaded via the communications network 1 or from a removable data storage device (RMD) for example. The controller 457 is configured to control the overall operation of the DU 5b by, in this example, program instructions or software instructions stored within memory 459.

As shown, these software instructions include, among other things, an operating system 461, a communications control module 463, an F1 module 465, an E2 module 467, a DU-RU module 468, a DU management module 472, and a UE profile management module 473.

The communications control module 463 is operable to control the communication between the DU 5b and the at least one RU 5a (and hence between the DU 5b and the UE 3), between the DU 5b and the CU 5c, and between the DU 5b and the RIC 13 (and in particular the near-RT RIC 13-2). The communications control module 463 is configured for the overall control of the reception of signals corresponding to uplink communications from the UE 3 and for handling the transmission of downlink communications destined for the UE 3.

The F1 module 465 is responsible for the appropriate processing of signals received from, or transmitted to, the CU 5c via the at least one CU (e.g. F1) interface 454. These signals may be separated into: user plane signals received from, or transmitted to, the CU-UP part of the CU 5c via the F1-U interface; and control plane signals received from, or transmitted to, the CU-CP part of the CU 5c via the F1-C interface.

The E2 module 467 is responsible for the appropriate processing of signals received from, or transmitted to, the RIC 13 (and in particular the near-RT RIC 13-2) via the at least one RIC (e.g. E2) interface 452.

The DU-RU module 468 is responsible for the appropriate processing of signals received from, or transmitted to, the RU 5a via the at least one RU (e.g. DU-RU) interface 453.

The DU management module 472 is responsible for managing the overall operation of the DU 5b and the overall performance of the tasks required of the DU 5b. These tasks include, among other things, the generation and transmission of appropriate messages using appropriate signalling application protocols, depending on the functional split between the RU 5a, DU 5b and CU 5c, such as interpretation of received MAC signalling and the generation of MAC signalling for transmission.

The UE profile management module 473 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. It will be appreciated that, depending on implementation, the gNB-DU 5b may not implement at least some of these features.

### RAN Equipment (CU)

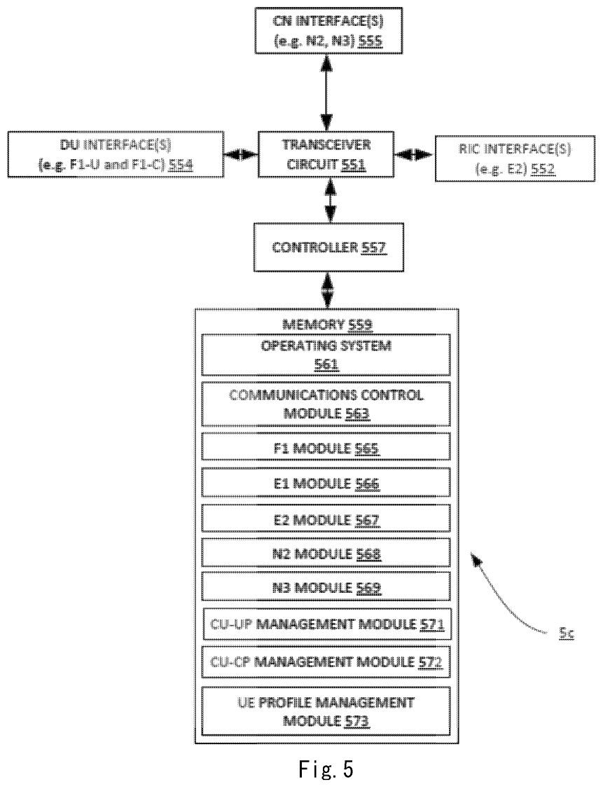

FIG. 5 is a schematic block diagram illustrating the main components of the CU 5c of the RAN equipment 5 for the communication system 1 shown in FIG. 1. As shown, the CU 5c has a transceiver circuit 551 for: transmitting signals to, and for receiving signals from, the DU 5b via the at least one DU interface 554 (e.g. comprising an F1 interface which may be split into an F1-U and an F1-C interface for user plane and control plane signalling respectively); for transmitting signals to, and for receiving signals from, the functions of the core network 7 via at least one core network interface 555 (e.g. comprising the N2 and N3 interfaces or the like); and for transmitting signals to and for receiving signals from the RIC 13 (and in particular the near-RT RIC 13-2) via a RIC interface 552 (e.g. comprising an E2 interface).

The CU 5c has a controller 557 to control the operation of the CU 5c. The controller 557 is associated with a memory 559. Software may be pre-installed in the memory 559 and/or may be downloaded via the communications network 1 or from a removable data storage device (RMD) for example. The controller 557 is configured to control the overall operation of the CU 5b by, in this example, program instructions or software instructions stored within memory 559.

As shown, these software instructions include, among other things, an operating system 561, a communications control module 563, an F1 module 565, an E1 module 566, an E2 module 567, an N2 module 568, an N3 module 569, a CU-UP management module 571, a CU-CP management module 572, and a UE profile management module 573.

The communications control module 563 is operable to control the communication between the CU 5c and the at least one DU 5b (and hence between the CU 5c and the UE 3), between the CU 5c and the core network 7, and between the CU 5c and the RIC 13 (and in particular the near-RT RIC 13-2). The communications control module 563 is configured for the overall control of the reception of signals corresponding to uplink communications from the UE 3 and for handling the transmission of downlink communications destined for the UE 3.

The F1 module 565 is responsible for the appropriate processing of signals received from, or transmitted to, the DU 5b via the at least one DU (e.g. F1) interface 554. These signals may be separated into: user plane signals received at, or transmitted by, the CU-UP part of the CU 5c via the F1-U interface; and control plane signals received at, or transmitted by, the CU-CP part of the CU 5c via the F1-C interface.

The E1 module 566 is responsible for the appropriate processing of signals transmitted between the CU-UP part of the CU 5c and the CU-CP part of the CU 5c via the corresponding internal CU interface (e.g. E1).

The E2 module 567 is responsible for the appropriate processing of signals received from, or transmitted to, the RIC 13 (and in particular the near-RT RIC 13-2) via the at least one RIC (e.g. E2) interface 552.

The N2 module 568 is responsible for the appropriate processing of signals received from, or transmitted to, the AMF 10-1 via the at least one corresponding core network interface (e.g. N2) 555.

The N3 module 569 is responsible for the appropriate processing of signals received from, or transmitted to, the core network user plane function(s) 11 via the at least one corresponding core network interface (e.g. N3) 555.

The CU-UP management module 571 is responsible for managing the overall operation of the CU-UP part of the CU 5c and the overall performance of the tasks required of the CU-UP.

The CU-CP management module 572 is responsible for managing the overall operation of the CU-CP part of the CU 5c and the overall performance of the tasks required of the CU-CP. These tasks include, among other things, the generation and transmission of appropriate messages using appropriate signalling application protocols, depending on the functional split between the RU 5a, DU 5b and CU 5c, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of configuration information for configuring the UE appropriately with mobility based configurations. It will be appreciated that, depending on implementation, the gNB-CU 5c may not implement at least some of these features.

RAN Equipment (Integrated gNB)

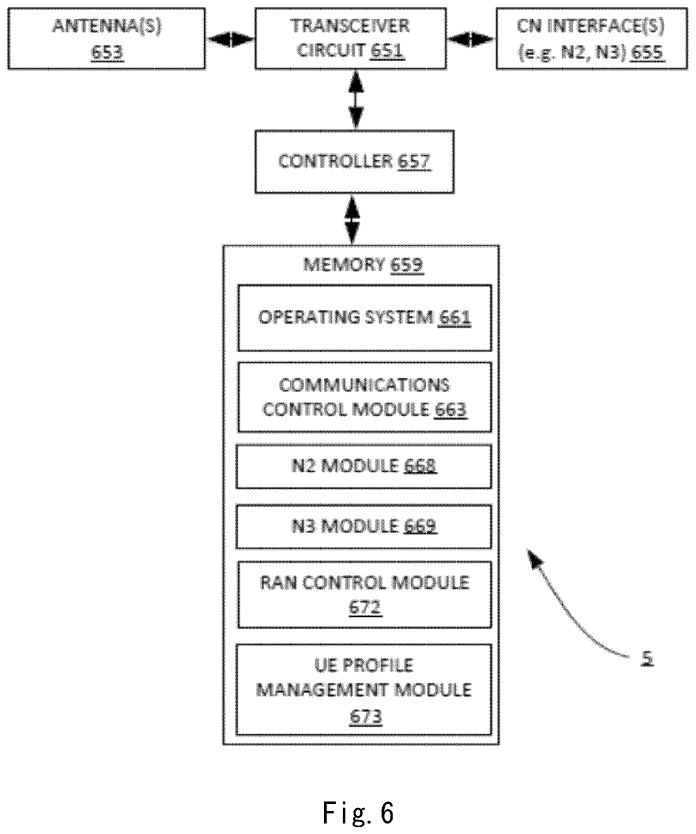

FIG. 6 is a schematic block diagram illustrating the main components of an integrated gNB that may be used as RAN equipment 5 in the communication system 1 shown in FIG. 1. As shown, the gNB 5 has a transceiver circuit 651 for: transmitting signals to, and for receiving signals from, the communication devices (such as UEs 3) via one or more antenna 653 (e.g. an antenna array/massive antenna); and for transmitting signals to, and for receiving signals from, the functions of the core network 7 via at least one core network interface 655 (e.g. comprising the N2 and N3 interfaces or the like).

The gNB 5 has a controller 657 to control the operation of the gNB 5. The controller 657 is associated with a memory 659. Software may be pre-installed in the memory 659 and/or may be downloaded via the communications network 1 or from a removable data storage device (RMD) for example. The controller 657 is configured to control the overall operation of the gNB 5 by, in this example, program instructions or software instructions stored within memory 659.

As shown, these software instructions include, among other things, an operating system 661, a communications control module 663, an N2 module 668, an N3 module 669, a RAN control module 672, and a UE profile management module 673.

The communications control module 663 is operable to control the communication between the gNB 5 and the UE 3 and between the gNB 5 and the core network 7. The communications control module 663 is configured for the overall control of the reception of uplink communications from the UE 3 and for handling the transmission of downlink communications to the UE 3.

The N2 module 668 is responsible for the appropriate processing of signals received from, or transmitted to, the AMF 10-1 via the at least one corresponding core network interface (e.g. N2) 655.

The N3 module 669 is responsible for the appropriate processing of signals received from, or transmitted to, the at least one core network user plane function 11 via the at least one corresponding core network interface (e.g. N3) 655.

The RAN control module 572 is responsible for managing the overall operation of the gNB 5 and the overall performance of the tasks required of the gNB 5. In effect, in this integrated gNB, the RAN control module 572 performs the RAN control tasks performed by the RIC 13 of FIG. 1. It will be appreciated, however, that an integrated gNB 5 comprising the functionality of the RU 5a, DU 5b and CU 5c may be configured to operated under the control of the RIC 13 rather than have the functionality of the RIC 13 integrated into the gNB.

The UE profile management module 673 is responsible for carrying out functions related to the UE (mobility) profile including (where applicable): the building, updating, storage and maintenance of the UE profile; the reception and storage of the UE profile or related assistance/preference information from the UE 3 or from elsewhere in the network; the determination of appropriate mobility specific configurations, based on the UE profile/assistance information/preference information, for implementation at the UE 3 and/or RAN equipment 5; and/or the provision of mobility specific configuration information for configuring the UE appropriately with mobility specific configurations. It will be appreciated that, depending on implementation, the gNB 5 may not implement at least some of these features.

### Near-RT RIC

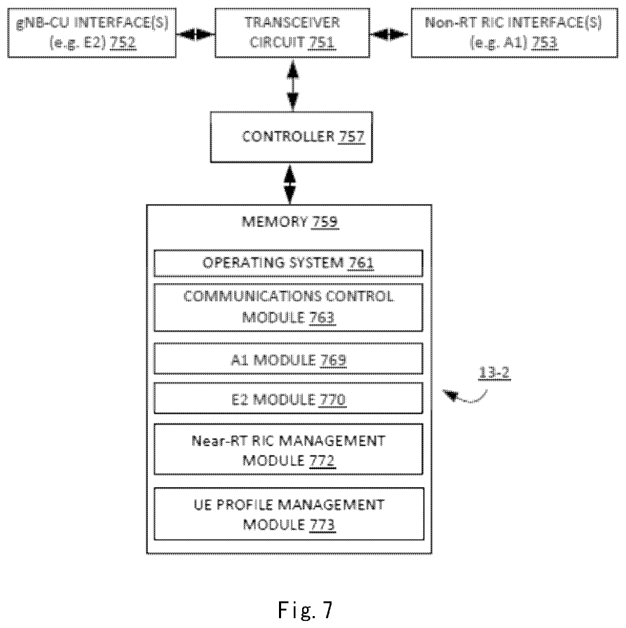

FIG. 7 is a schematic block diagram illustrating the main components of the near-RT RIC 13-2 of the communication system 1 shown in FIG. 1. As shown, the near-RT RIC 13-2 has a transceiver circuit 751 for: transmitting signals to, and for receiving signals from, the CU 5c of the RAN equipment 5 via the at least one gNB-CU interface (e.g. E2) 752; and for transmitting signals to, and for receiving signals from, the non-RT RIC 13-1 via the at least one non-RT RIC interface (e.g. A1) 753.

The near-RT RIC 13-2 has a controller 757 to control the operation of the near-RT RIC 13-2. The controller 757 is associated with a memory 759. Software may be pre-installed in the memory 759 and/or may be downloaded via the communications network 1 or from a removable data storage device (RMD) for example. The controller 757 is configured to control the overall operation of the near-RT RIC 13-2 by, in this example, program instructions or software instructions stored within memory 759.

As shown, these software instructions include, among other things, an operating system 761, a communications control module 763, an A1 module 769, an E2 module 770, a near-RT RIC management module 772, and a UE profile management module 773.

The communications control module 763 is operable to control the communication between the near-RT RIC 13-2 and the RAN equipment 5, and between the near-RT RIC 13-2 and the non-RT RIC 13-1.

The A1 module 769 is responsible for the appropriate processing of signals received from, or transmitted to, the non-RT RIC 13-1 via the at least one corresponding non-RT RIC interface (e.g. A1) 753.

The E2 module 770 is responsible for the appropriate processing of signals received from, or transmitted to, the CU 5c of the RAN equipment 5 via the at least one gNB-CU interface (e.g. E2) 752.

The near-RT RIC management module 772 is responsible for managing the overall operation of the near-RT RIC 13-2 and the overall performance of the tasks required of the near-RT RIC 13-2. For example, the near-RT RIC management module 772 may be responsible for tasks such as monitoring, suspending/stopping, overriding, or controlling the RAN equipment 5 via non-RT RIC enabled policies. The near-RT RIC management module 772 may support tasks that require short (<1s) latencies, for per-UE controlled load-balancing, resource (resource block (RB)) management, interference detection and mitigation.

The UE profile management module 773 is responsible for carrying out functions related to the UE (mobility) profile including (where applicable): the building, updating, storage and maintenance of the UE profile; the reception and storage of the UE profile or related assistance/preference information from the UE 3 or from elsewhere in the network including the non-RT RIC 13-1; the determination of appropriate mobility specific configurations, based on the UE profile/assistance information/preference information, for implementation at the UE 3 and/or RAN equipment 5; the provision of the UE profile, related assistance information, and or mobility specific configuration information to the RAN equipment 5 for use by the RAN in the determination of mobility specific configurations for the UE 3 represented by the UE profile. It will be appreciated that, depending on implementation, the near-RT RIC 13-2 may not implement at least some of these features.

### Non-RT RIC

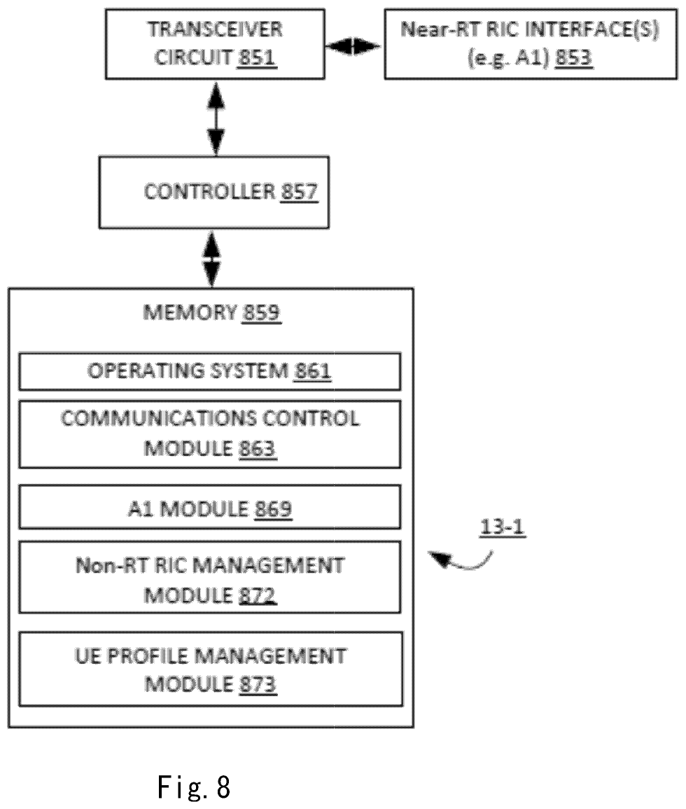

FIG. 8 is a schematic block diagram illustrating the main components of the non-RT RIC 13-1 of the communication system 1 shown in FIG. 1. As shown, the non-RT RIC 13-1 has a transceiver circuit 851 for: transmitting signals to, and for receiving signals from, the near-RT RIC 13-2 via the at least one near-RT RIC interface (e.g. A1) 852.

The non-RT RIC 13-1 has a controller 857 to control the operation of the non-RT RIC 13-1. The controller 857 is associated with a memory 859. Software may be pre-installed in the memory 859 and/or may be downloaded via the communications network 1 or from a removable data storage device (RMD) for example. The controller 857 is configured to control the overall operation of the non-RT RIC 13-1 by, in this example, program instructions or software instructions stored within memory 859.

As shown, these software instructions include, among other things, an operating system 861, a communications control module 863, an A1 module 869, a non-RT RIC management module 872, and a UE profile management module 873.

The communications control module 863 is operable to control the communication between the non-RT RIC 13-1 and the near-RT RIC 13-2 (and possibly directly with the RAN equipment 5).

The A1 module 869 is responsible for the appropriate processing of signals received from, or transmitted to, the near-RT RIC 13-2 via the at least one corresponding near-RT RIC interface (e.g. A1) 853.

The non-RT RIC management module 872 is responsible for managing the overall operation of the non-RT RIC 13-1 and the overall performance of the tasks required of the non-RT RIC 13-1. For example, the non-RT RIC management module 872 may be responsible for tasks such as configuration management, device management, fault management, performance management, and lifecycle management for all network elements in the network. The non-RT RIC management module 872 may support tasks that require longer (>1s) latencies.

The UE profile management module 873 is responsible for carrying out functions related to the UE (mobility) profile including (where applicable): the building, updating, storage and maintenance of the UE profile; the reception and storage of the UE profile or related assistance/preference information from the UE 3 or from elsewhere in the network; and the provision of the UE profile and/or related assistance/preference information to the RAN equipment 5, either directly or indirectly via the near-RT RIC 13-2, for use in determination of mobility specific configurations for the UE 3 represented by the UE profile. It will be appreciated that, depending on implementation, the non-RT RIC 13-1 may not implement at least some of these features.

### Network Node

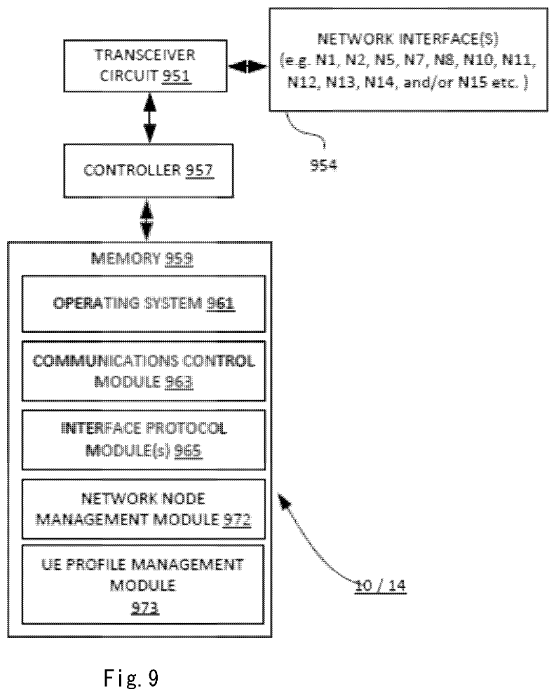

FIG. 9 is a schematic block diagram illustrating the main components of a generic network node of the communication system 1 shown in FIG. 1. The network node may be configured as any network entity such as a control plane function 10 (AMF, UDM, SMF etc.) or OAM function 14.

As shown, the network node has a transceiver circuit 951 for: transmitting signals to, and for receiving signals from, other network nodes via corresponding (network) interfaces 954 (e.g. N1, N2, N5, N7, N8, N10, N11, N12, N13, N14, N15, and/or at least one OAM interface with the core network/RAN equipment or the like etc.).

The network node has a controller 957 to control the operation of the network node. The controller 957 is associated with a memory 959. Software may be pre-installed in the memory 959 and/or may be downloaded via the communications network 1 or from a removable data storage device (RMD) for example. The controller 957 is configured to control the overall operation of the network node by, in this example, program instructions or software instructions stored within memory 959.

As shown, these software instructions include, among other things, an operating system 961, a communications control module 963, one or more interface protocol modules 965, a network node management module 972, and a UE profile management module 973.

The communications control module 963 is operable to control the communication between the network node and one or more other network entities in the communications system.

The at least one interface protocol module 965 is responsible for the appropriate processing of signals received from, or transmitted to, the other network entity or entities via the at least one corresponding (network) interface 954.

The one or more management module 972 is responsible for managing the overall operation of the network node and the overall performance of the tasks required of that network node. For example, where the network node is a UDM 10-3 the tasks include tasks related to managing data for access authorization, user registration, and data network profiles, and providing subscriber data to the SMF etc. Where the network node is an OAM 14 the tasks include tasks related to provisioning and managing network or elements within the wider communication system etc. Where the network node is an AMF 10-1, the tasks include tasks related to mobility management related functions, maintaining the non-NAS signalling connection with each UE 3, managing UE registration, receiving user information sent through the network, forwarding that information to the SMF 10-2, managing paging etc. Where the network node is an SMF 10-2, the tasks include tasks related to providing session management functionality, using user information provided via the AMF 10-1 to determine what session manager would be best assigned to the user, allocating IP addresses to each UE 3, determine NAS configurations (which may include a mobility specific NAS configuration for a UE 3 to which a particular UE profile relates) etc.

The UE profile management module 973 is responsible for carrying out functions related to the UE (mobility) profile including (where applicable): the building, updating, storage and maintenance of the UE profile; the reception and storage of the UE profile or related assistance/preference information from the UE 3 or from elsewhere in the network; and the provision of the UE profile and/or related assistance/preference information to the RAN equipment 5, either directly or indirectly, for use in generation of mobility specific configurations for the UE 3 represented by the UE profile. It will be appreciated that, depending on implementation, the network node may not implement at least some of these features.

### Network-Based UE Profile

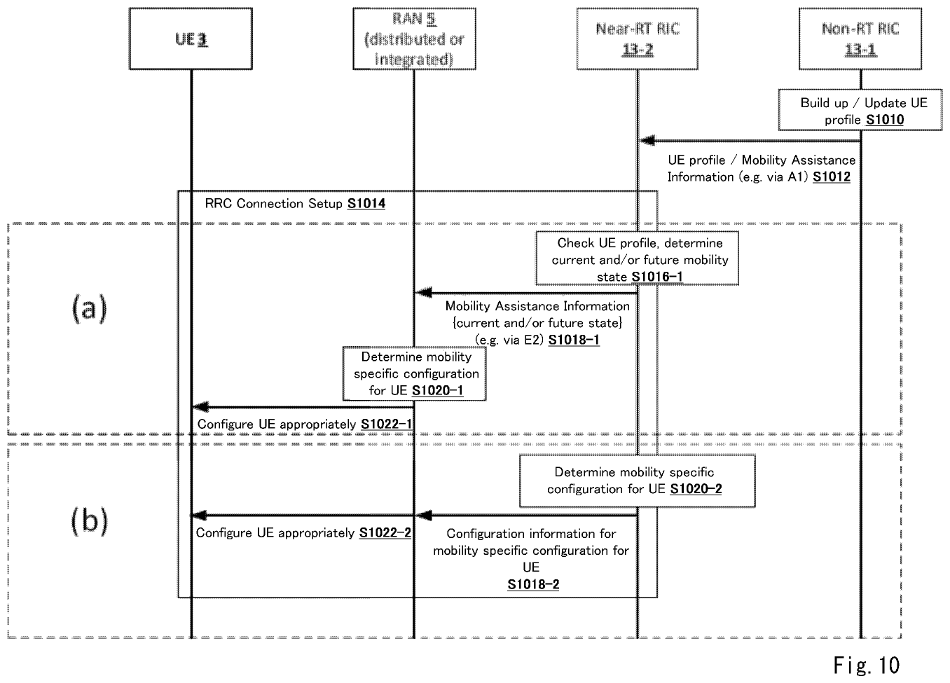

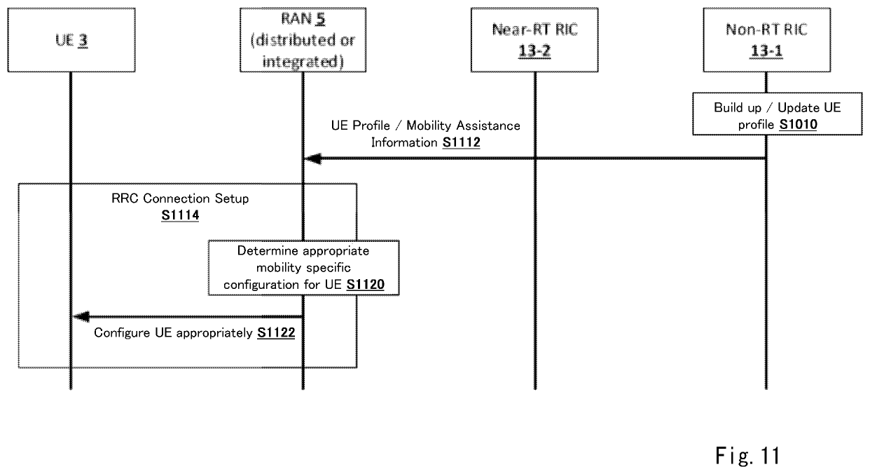

Examples of a network-based UE profile procedure will now be described, by way of example only, with reference to FIGS. 10 and 11.

FIG. 10 is a simplified timing diagram illustrating two possible procedures (labelled (a) and (b)) for providing the UE 3 with a mobility specific configuration.

In both exemplary procedures, the non-RT RIC 13-1 builds up (or updates) a UE profile for a specific UE 3 at S1010. This (updated) UE profile (or assistance information derived from it such as an indication of a mobility state) is then shared (e.g. by the A1 interface) to the near RT RIC 13-2 (at S1012).

In the first exemplary procedure (a), after an RRC connection setup procedure is initiated by the UE 3, during the RRC connection setup procedure (S1014), the near RT RIC 13-2 checks the UE profile provided by the non-RT RIC 13-1, determines a current and/or predicts a future mobility state at S1016-1 and then provides this as mobility assistance information to the RAN equipment 5 at S1018-1 (e.g. over the E2 interface). The RAN equipment 5 (CU 5c and/or DU 5b in the case of a distributed RAN) uses the information provided to determine an appropriate mobility specific configuration for the UE 3 at S1020-1. The RAN equipment 5 then provides configuration information for configuring the UE 3 with the mobility specific configuration, using appropriate signalling, at S1022-1 (e.g. using appropriate RRC signalling such as an RRC reconfiguration message or other similar message). The UE 3 can then configure itself accordingly based on the received configuration information.

In the second exemplary procedure (b), after an RRC connection setup procedure is initiated by the UE 3, during the RRC connection setup procedure (S1014), the near RT RIC 13-2 determines an appropriate mobility configuration for the UE 3 based on the UE profile for that UE 3 at S1020-2 (e.g. based on a current and/or predicted mobility state derived from the UE profile) and then provides, at S1018-2, configuration information representing the determined mobility specific configuration to the RAN equipment 5 for configuring the UE 3. The RAN equipment 5 (CU 5c and/or DU 5b in the case of a distributed RAN) then provides corresponding configuration information for configuring the UE 3 with the mobility specific configuration, using appropriate signalling, at S1022-2 (e.g. using appropriate RRC signalling). The UE 3 can then configure itself accordingly based on the received configuration information.

FIG. 11 is another simplified timing diagram illustrating a possible procedure for providing the UE 3 with a mobility specific configuration.

In this example, the non-RT RIC 13-1 builds up (or updates) a UE profile for a specific UE 3 at S1110. This (updated) UE profile (or assistance information derived from it such as an indication of a mobility state) is then provided directly to the RAN equipment 5 (at S1112).

After an RRC connection setup procedure is initiated by the UE 3, during the RRC connection setup procedure (S1114), the RAN equipment 5 (CU 5c and/or DU 5b in the case of a distributed RAN) uses the information provided to determine an appropriate mobility specific configuration for the UE 3 at S1120. The RAN equipment 5 then provides configuration information for configuring the UE 3 with the mobility specific configuration, using appropriate signalling, at S1122 (e.g. using appropriate RRC signalling). The UE 3 can then configure itself accordingly based on the received configuration information.

RRC/MAC layer provision of UE Profile

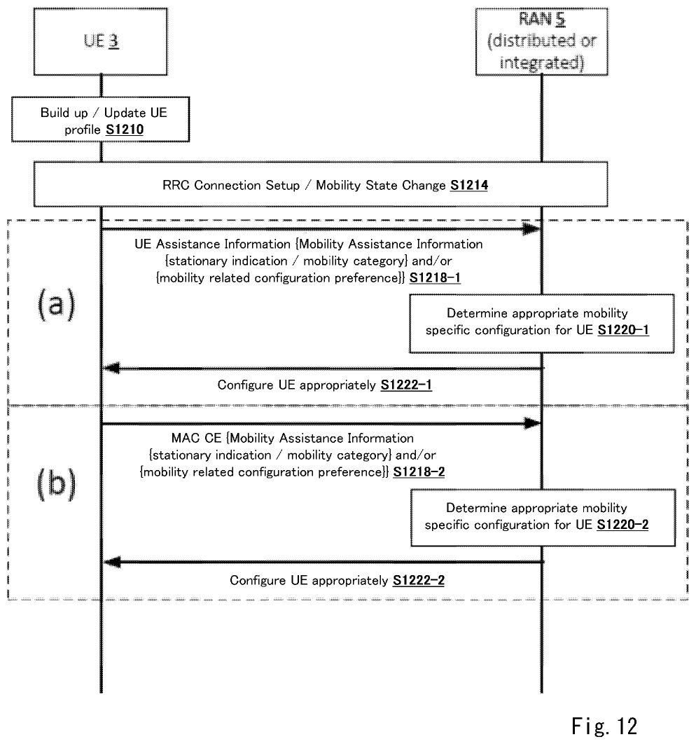

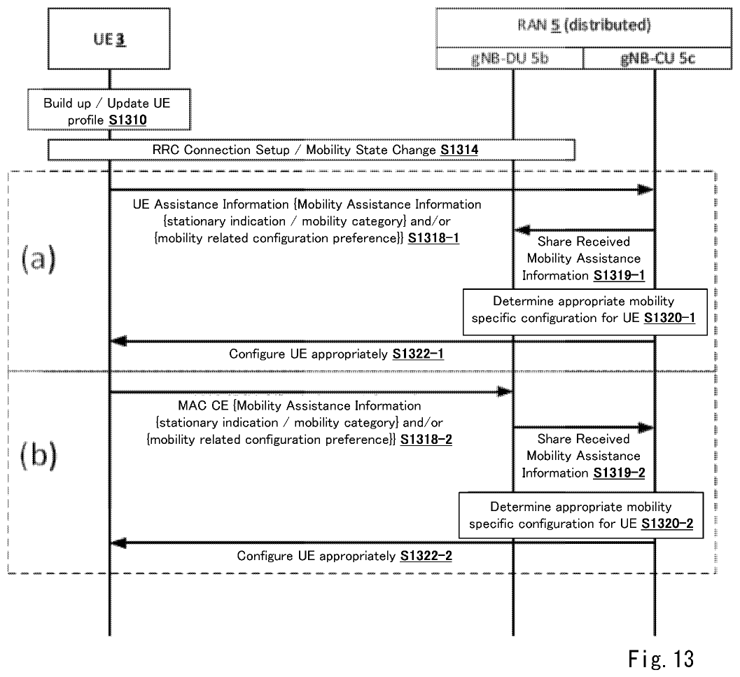

Examples of a UE-based UE profile procedure involving RRC/MAC layer signalling will now be described, by way of example only, with reference to FIGS. 12 and 13.

FIG. 12 is a simplified timing diagram illustrating two possible procedures (labelled (a) and (b)) for providing the UE 3 with a mobility specific configuration.

In both exemplary procedures, the UE 3 builds up (or updates) a UE profile for that UE 3 at S1210.

In the first exemplary procedure (a), upon RRC connection or a change in the mobility state of the UE 3 (at S1214) the UE provides (at S1218-1) mobility assistance information to the RAN equipment 5 using RRC signalling—in this example using a UE assistance information message. The RAN equipment 5 (CU 5c and/or DU 5b in the case of a distributed RAN) uses the information provided to determine an appropriate mobility specific configuration for the UE 3 at S1220-1. The RAN equipment 5 then provides configuration information for configuring the UE 3 with the mobility specific configuration, using appropriate signalling, at S1222-1 (e.g. using appropriate RRC signalling such as an RRC reconfiguration message or other similar message). The UE 3 can then configure itself accordingly based on the received configuration information.

In the second exemplary procedure (b), upon RRC connection or a change in the mobility state of the UE 3 (at S1214) the UE provides (at S1218-2) mobility assistance information to the RAN equipment 5 using a MAC CE. The RAN equipment 5 (CU 5c and/or DU 5b in the case of a distributed RAN) uses the information provided to determine an appropriate mobility specific configuration for the UE 3 at S1220-2. The RAN equipment 5 then provides configuration information for configuring the UE 3 with the mobility specific configuration, using appropriate signalling, at S1222-2 (e.g. using appropriate RRC signalling such as an RRC reconfiguration message, MAC CE, or other similar message). The UE 3 can then configure itself accordingly based on the received configuration information.

FIG. 13 is a simplified timing diagram illustrating, in more detail, the two possible procedures illustrated in FIG. 12 in the specific context of a distributed RAN equipment 5.

In both exemplary procedures, the UE 3 builds up (or updates) a UE profile for that UE 3 at S1310.

In the first exemplary procedure (a), upon RRC connection or a change in the mobility state of the UE 3 (at S1314) the UE provides (at S1318-1) mobility assistance information to the gNB-CU 5c of the RAN equipment 5 using RRC signalling—in this example using a UE assistance information message. The gNB-CU 5c of the RAN equipment 5 shares the received information with the gNB-DU 5b of the RAN equipment 5 at S1319-1 (e.g. over the F1 interface). The gNB-CU 5c and/or the gNB-DU 5b then uses the mobility assistance information to determine an appropriate mobility specific configuration for the UE 3 at S1320-1. The gNB-CU 5c then provides configuration information for configuring the UE 3 with the mobility specific configuration, using appropriate signalling, at S1322-1 (e.g. using appropriate RRC signalling). The UE 3 can then configure itself accordingly based on the received configuration information.

In the second exemplary procedure (b), upon RRC connection or a change in the mobility state of the UE 3 (at S1314) the UE provides (at S1318-2) mobility assistance information to the gNB-DU 5b of the RAN equipment 5 using a MAC CE message. The gNB-DU 5b of the RAN equipment 5 shares the received information with the gNB-CU 5c of the RAN equipment 5 at S1319-2 (e.g. over the F1 interface). The gNB-CU 5c and/or the gNB-DU 5b then uses the mobility assistance information to determine an appropriate mobility specific configuration for the UE 3 at S1320-2. The gNB-CU 5c then provides configuration information for configuring the UE 3 with the mobility specific configuration, using appropriate signalling, at S1322-1 (e.g. using appropriate RRC signalling). The UE 3 can then configure itself accordingly based on the received configuration information.

It will be appreciated that whilst the second exemplary procedure (b) shows the configuration being signalled by the CU 5c, the DU 5b may provide part, or all, of the mobility specific configuration to the CU 5c (or possibly to the UE 3 using a MAC CE). For example, the DU 5b may provide the UE configurations such as lower layer relevant configurations (e.g. TAT, PC) to the CU 5c, and CU 5c sends this configuration to the UE 3. Typically, in a CU-DU split architecture, lower layer configuration parameters will be set by the DU 5b and higher layer configuration parameter will be set by the CU 5c.

In any of the examples described with reference to FIGS. 12 and 13, the mobility assistance information may comprise a direct indication, for example a stationary indication for indicating whether or not the UE 3 is (quasi) stationary (e.g. a single bit set to ‘l’ to indicate the UE 3 is (quasi) stationary or ‘0’ to indicate that the UE is not (quasi) stationary (or vice versa)). Alternatively, or additionally, a direct indication may comprise an indication of one of a plurality of mobility categories (e.g. (quasi)stationary, moving within a limited geographic area, moving between two specific points, random mobility, low mobility, medium mobility, high mobility, or the like). The mobility assistance information may, alternatively or additionally, comprise an indirect indication. An indirect indication may comprise, for example, a configuration preference that is relevant to mobility (e.g. a bigger/infinite TAT is preferred, relaxed radio resource management (RRM) measurement is preferred, no (or less) measurement configuration is preferred, no handover is preferred and so on).

### NAS/Higher Layer Provision of UE Profile

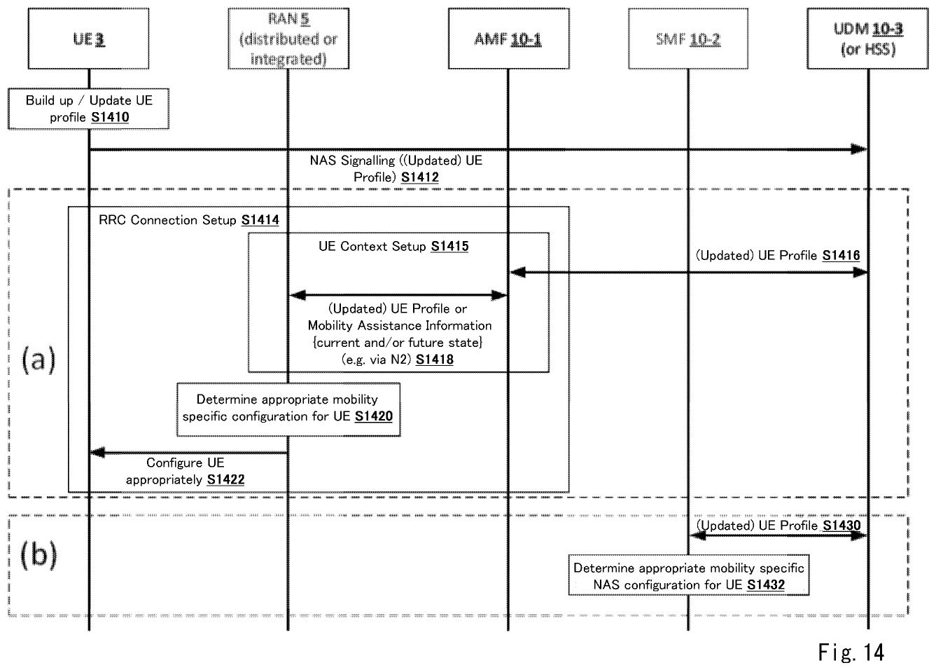

An example of a UE-based UE profile procedure involving NAS/higher layer signalling will now be described, by way of example only, with reference to FIG. 14.

FIG. 14 is a simplified timing diagram illustrating two possible procedures (labelled (a) and (b)) for providing a mobility specific configuration specific to the UE 3.

In both exemplary procedures, the UE 3 builds up (or updates) a UE profile for that UE 3 at S1410. This (updated) UE profile is then provided to the core network 7 (in this example the UDM 10-3 although it may be another network node) at S1412.

In the first exemplary procedure (a), the (updated) UE profile is shared with the AMF 10-1 (e.g. via the N8 interface). After an RRC connection setup procedure is initiated by the UE 3, during the RRC connection setup procedure (S1414) and, more specifically, during UE context setup (S1415), the AMF 10-1 obtains the (updated) UE profile from the UDM 10-3 as shown at S1416 (or possibly obtains the profile from memory if the AMF has acquired the (updated) UE profile from the UDM 10-3 earlier). The AMF 10-1 provides this (updated) UE profile, or mobility assistance information derived from it (e.g. information identifying a current and/or a predicted future mobility state), to the RAN equipment 5 at S1418 (e.g. via the N2 interface). The RAN equipment 5 (CU 5c and/or DU 5b in the case of a distributed RAN) uses the information provided to determine an appropriate mobility specific configuration for the UE 3 at S1420. The RAN equipment 5 then provides configuration information for configuring the UE 3 with the mobility specific configuration, using appropriate signalling, at S1422 (e.g. using appropriate RRC signalling). The UE 3 can then configure itself accordingly based on the received configuration information.

In the second exemplary procedure (b), the (updated) UE profile is shared with the SMF 10-2 (e.g. via the N10 interface) at S1430 where an appropriate mobility specific NAS configuration for UE is determined at S1432. For example, based on the UE profile the core network 7 may optimize the NAS configuration for a specific UE for prioritising where to page the UE first based on a prediction of where (e.g. a specific cell or optimised paging area) the UE is located. Such a prediction may identify a single location (cell or optimised paging area) or a list of such locations that is ordered in order of decreasing reliability (or confidence level). Similarly, the core network may adjust or optimise a registration area associated with the UE based on information derived from the UE profile.

### Hybrid Example—UE and Network Involved in UE Profile Generation

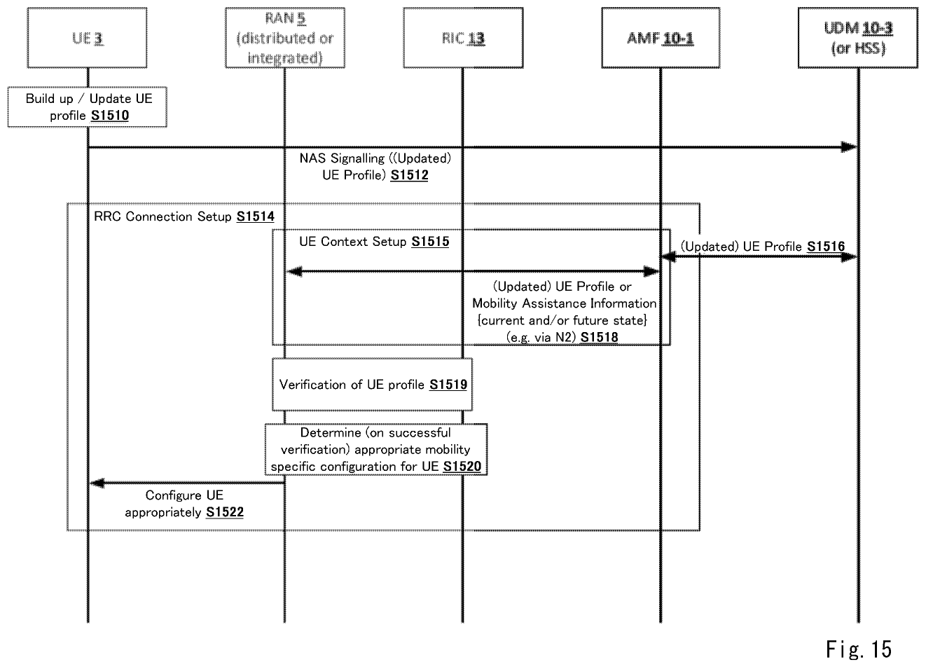

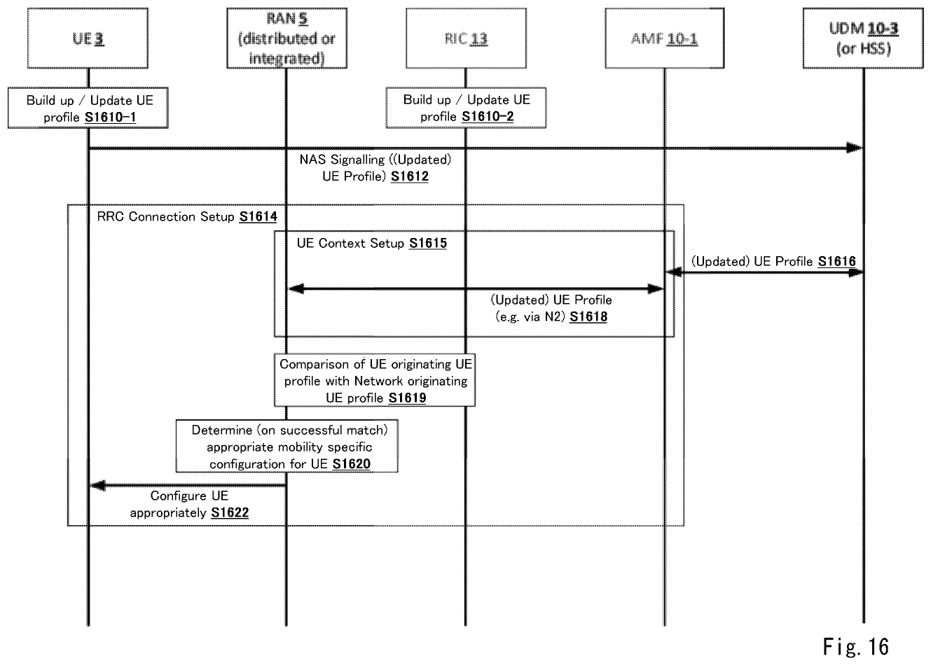

Examples of a hybrid UE/Network-based UE profile procedure will now be described, by way of example only, with reference to FIGS. 15 and 16.

FIG. 15 is a simplified timing diagram illustrating another possible procedure for providing the UE 3 with a mobility specific configuration.

In this exemplary procedure, the UE 3 builds up (or updates) a UE profile for that UE 3 at S1510. This (updated) UE profile is then provided to the core network 7 (in this example the UDM 10-3 although it may be another network node) at S1512.

The (updated) UE profile is shared with the AMF 10-1 (e.g. via the N8 interface). After an RRC connection setup procedure is initiated by the UE 3, during the RRC connection setup procedure (S1514) and, more specifically, during UE context setup (S1515), the AMF 10-1 obtains the (updated) UE profile from the UDM 10-3 as shown at S1516 (or possibly obtains the profile from memory if the AMF has acquired the (updated) UE profile from the UDM 10-3 earlier). The AMF 10-1 provides this (updated) UE profile, or mobility assistance information derived from it (e.g. information identifying a current and/or a predicted future mobility state), to the RAN equipment 5 at S1518 (e.g. via the N2 interface). The RAN equipment 5 (CU 5c and/or DU 5b in the case of a distributed RAN) and/or the RIC 13 (near-RT or non-RT) then verifies the UE profile as S1519. This verification may, for example, be carried out by comparing, a predicted location and/or predicted movement of the UE 3 based on the UE profile reported by the UE 3, with live location information and/or measurement data for that UE 3 collected by network from that UE 3. The UE profile may then be used, as described in previous examples, subject to successful verification.

On successful verification the RAN equipment 5 (or possibly RIC 13 as described with reference to FIG. 10) uses the information provided to determine an appropriate mobility specific configuration for the UE 3 at S1520. The RAN equipment 5 then provides configuration information for configuring the UE 3 with the mobility specific configuration, using appropriate signalling, at S1522 (e.g. using appropriate RRC signalling). The UE 3 can then configure itself accordingly based on the received configuration information.

FIG. 16 is a simplified timing diagram illustrating another possible procedure for providing the UE 3 with a mobility specific configuration.

In this exemplary procedure, the UE 3 builds (or updates) a UE profile for that UE 3 at S1610-1. In parallel, the RIC 13 (near-RT or non-RT) builds (or updates) a network-based UE profile for that UE 3 at S1610-2. The (updated) UE profile generated by the UE 3 is provided to the core network 7 (in this example the UDM 10-3 although it may be another network node) at S1612.

The (updated) UE profile is shared with the AMF 10-1 (e.g. via the N8 interface). After an RRC connection setup procedure is initiated by the UE 3, during the RRC connection setup procedure (S1614) and, more specifically, during UE context setup (S1615), the AMF 10-1 obtains the (updated) UE profile from the UDM 10-3 as shown at S1616 (or possibly obtains the profile from memory if the AMF has acquired the (updated) UE profile from the UDM 10-3 earlier). The AMF 10-1 provides this (updated) UE profile, or mobility assistance information derived from it (e.g. information identifying a current and/or a predicted future mobility state), to the RAN equipment 5 at S1618 (e.g. via the N2 interface). The RAN equipment 5 (CU 5c and/or DU 5b in the case of a distributed RAN) and/or the RIC 13 (near-RT or non-RT) then performs a verification of the UE profile by comparing of the UE originating profile (built by the UE at 1610-1) received from the core network with the network-based UE profile (built by the network at 1610-2) to determine if there is a sufficient match (a predefined level of similarity between the different UE profiles) (S1619).

In the event of a successful match, the RAN equipment 5 (or possibly RIC 13 as described with reference to FIG. 10) uses the information provided to determine an appropriate mobility specific configuration for the UE 3 at S1620. The RAN equipment 5 then provides configuration information for configuring the UE 3 with the mobility specific configuration, using appropriate signalling, at S1622 (e.g. using appropriate RRC signalling). The UE 3 can then configure itself accordingly based on the received configuration information.

### Modifications and Alternatives

Detailed examples of various improvements have been described above. As those skilled in the art will appreciate, a number of modifications and alternatives can be made to the above examples whilst still benefiting from the disclosures embodied therein.

For example, it will be appreciated that, whilst the new and beneficial features of the devices of the telecommunication network have been described, in particular, with reference to 5G/NR communication technology, the beneficial features may be implemented in the devices of a telecommunication system that uses other communication technologies such as, for example, other communication technologies developed as part of the 3GPP. For example, whilst the base station and UEs have been described as a 5G base station (gNB) and corresponding UEs it will be appreciated that the features described above may be applied to the RAN nodes (eNBs) and UEs that implement LTE/LTE-Advanced communication technology, or RAN nodes and UEs that implement other communications technologies developed using 3GPP derived communication technologies.

In the above description, the UEs and the base station are described for ease of understanding as having a number of discrete functional components or modules. Whilst these modules may be provided in this way for certain applications, for example where an existing system has been modified to implement the present disclosure, in other applications, for example in systems designed with the features of the present disclosure in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

The software module or the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IOT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX

(Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency

Wireless Communication Service, a community service, a video streaming service, a femto cell application service, a VOLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from United Kingdom patent application No. 2106571.9, filed on May 7, 2021, the disclosure of which is incorporated herein in its entirety by reference.

The whole or part of the example embodiments disclosed above can be described as, but not limited to, the following supplementary notes.

### Supplementary Note 1

A method performed by a first network entity in a communication system, the method comprising:
obtaining information relating to a mobility state of a user equipment (UE);
determining a mobility specific configuration for the UE based on the mobility state; and
providing configuration information for configuring the UE with the mobility specific configuration.

### Supplementary Note 2

The method according to Supplementary note 1, further comprising:
performing a verification of the information relating to the mobility state of the UE before determining the mobility specific configuration, wherein
the determining is performed in a case where the verification is successful.

### Supplementary Note 3

The method according to Supplementary note 2, wherein the performing the verification is performed based on a comparison of, a predicted location and/or predicted movement of the UE with location information and/or measurement data for the UE collected from the UE.

### Supplementary Note 4

The method according to Supplementary note 2, wherein the performing the verification is performed based on a comparison of the information relating to the mobility state of the UE with another information relating to a mobility state of the UE generated by the first network entity or another network entity.

### Supplementary Note 5

The method according to any one of Supplementary notes 1 to 4, wherein
the information relating to the mobility state of the UE includes information identifying a current and/or predicted mobility state for the UE, and
the determining is performed based on the current and/or predicted mobility state for the UE.

### Supplementary Note 6

The method according to any one of Supplementary notes 1 to 5, wherein the information relating to the mobility state of the UE includes an indication for indicating whether or not the UE is stationary or near-stationary, and/or an indication for indicating one of a plurality of mobility categories into which movement of the UE has been categorised.

### Supplementary Note 7

The method according to any one of Supplementary notes 1 to 6, wherein the information relating to the mobility state of the UE includes an indication for indicating a mobility related configuration preference.

### Supplementary Note 8

The method according to any one of Supplementary notes 1 to 7, wherein the information relating to the mobility state of the UE is included in at least one of:
a radio resource control (RRC) message;
a UE Assistance Information Message;
a media access control (MAC) control element (CE) message; and
a Non-Access Stratum (NAS) message.

### Supplementary Note 9

The method according to any one of Supplementary notes 1 to 8, wherein the mobility specific configuration for the UE includes one of, or a combination of, the following:
a mobility specific measurement configuration;
a mobility specific power control (PC) configuration;
a mobility specific power headroom reporting (PHR) configuration;
a mobility specific time alignment timer (TAT) configuration; and/or
a mobility specific paging area/tracking area configuration.

### Supplementary Note 10

The method according to any one of Supplementary notes 1 to 9, wherein the providing the configuration information is performed using one of:
a radio resource control (RRC) signalling; and
an RRC reconfiguration message.

### Supplementary Note 11

The method according to any one of Supplementary notes 1 to 10, wherein the information relating to the mobility state of the UE is included in a UE profile.

### Supplementary Note 12

The method according to any one of Supplementary notes 1 to 11, wherein
the obtaining includes receiving, from a second network entity, the information relating to the mobility state of the UE, and
the providing includes providing the configuration information, to the UE or to a third network entity.

### Supplementary Note 13

The method according to any one of Supplementary notes 1 to 11, wherein
the obtaining includes receiving, from the UE, the information relating to the mobility state of the UE, and
the providing includes providing the configuration information, to the UE or to a second network entity.

### Supplementary Note 14

The method according to Supplementary note 12 or 13, wherein the second network entity includes at least one of:
a radio access network (RAN) intelligent controller (RIC) entity,
a non-real time RIC; and
a near-real time RIC.

### Supplementary Note 15

The method according to Supplementary note 12 or 13, wherein the second network entity includes at least one of:
a core network control plane function,
a unified data management (UDM) function; and
a home subscriber server (HSS).

### Supplementary Note 16

The method according to Supplementary note 12 or 13, wherein the second network entity includes an Operations, Administration and Maintenance (OAM) function.

### Supplementary Note 17

The method according to any one of Supplementary notes 1 to 16, wherein the first network entity includes at least one of:
a radio access network (RAN) equipment,
a central unit (CU) of a base station,
a distributed unit (DU) of a base station, and
an integrated base station.

### Supplementary Note 18

The method according to any one of Supplementary notes 1 to 17, wherein the first network entity includes at least one of:
a radio access network (RAN) intelligent controller (RIC) entity,
a near-real time RIC; and
a non-real time RIC.

### Supplementary Note 19

The method according to any one of Supplementary notes 1 to 18, wherein the first network entity includes at least one of:
a core network control plane function, and
a session management function (SMF).

### Supplementary Note 20

A method performed by a user equipment (UE) in a communication system, the method comprising:
providing, to a network entity, information relating to a mobility state of the UE to support determining a mobility specific configuration for the UE.

### Supplementary Note 21

The method according to Supplementary note 20, further comprising receiving, from the network entity or another network entity, configuration information for configuring the UE with the mobility specific configuration.

### Supplementary Note 22

The method according to any one of Supplementary notes 1 to 21, wherein the information relating to the mobility state of the UE includes information identifying a device type of the UE corresponding to the mobility status of the UE.

### Supplementary Note 23

The method according to any one of Supplementary notes 1 to 22, wherein the information relating to the mobility state of the UE includes information identifying a location of the UE.

### Supplementary Note 24

The method according to any one of Supplementary notes 1 to 23, wherein the information relating to the mobility state of the UE includes any one of, or combination of, the following:
information identifying a time at, or time period within, which the UE is expected to be stationary;
information identifying a location in which the UE is expected to be stationary;
information identifying a time at, or time period within, which the UE is expected to be moving;
information identifying a location to which, or from which, the UE is expected to be moving;
information identifying a geographic area within which movement of the UE is expected to be confined; and/or
information identifying a reliability of information in the information relating to the mobility state of the UE.

### Supplementary Note 25

The method according to Supplementary note 24, wherein
the information relating to the mobility state of the UE includes information identifying a reliability of information in the information relating to the mobility state of the UE, and
the determining is performed based on the reliability.

### Supplementary Note 26

A first network entity for a communication system, the first network entity comprising:
means for obtaining information relating to a mobility state of a user equipment (UE);
means for determining a mobility specific configuration for the UE based on the mobility state; and
means for providing configuration information for configuring the UE with the mobility specific configuration.

### Supplementary Note 27

A user equipment (UE) for a communication system, the UE comprising:
means for providing, to a network entity, information relating to a mobility state of the UE to support determining a mobility specific configuration for the UE.

### REFERENCE SIGNS LIST

1 Communication system
3 User Equipment (UE)
5 Radio Access Network (RAN) equipment
5a Radio Unit (RU)
5b Distributed Unit (DU)
5c Central Unit (CU)
7 Core network
9 Cell
10 Control Plane Function (CPF)
10-1 Access and Mobility Management Function (AMF)
10-2 Session Management Function (SMF)
10-3 Unified Data Management (UDM) function
10-n Other function
11 User Plane Function (UPF)
13 RAN intelligent controller (RIC)
13-1 Non-real time RIC (non-RT-RIC)
13-2 Near-real time RIC (near-RT-RIC)
14 Operations, Administration and Maintenance (OAM)
20 External data network
231 Transceiver circuit
233 Antenna
235 User interface
237 Controller
239 Memory
241 Operating system
243 Communications control module
245 UE management module
247 UE profile management module
351 Transceiver circuit
353 Antenna
354 DU interface
357 Controller
359 Memory
361 Operating system
363 Communications control module
368 DU-RU module
372 RU management module
451 Transceiver circuit
452 RIC interface
453 RU interface
454 CU interface
457 Controller
459 Memory
461 Operating system
463 Communications control module
465 F1 module
467 E2 module
468 DU-RU module
472 DU management module
473 UE profile management module
551 Transceiver circuit
552 RIC interface
554 DU interface
555 Core Network (CN) interface
557 Controller
559 Memory
561 Operating system
563 Communications control module
565 F1 module
566 E1 module
567 E2 module
568 N2 module
569 N3 module
571 CU-UP management module
572 CU-CP management module
573 UE profile management module
651 Transceiver circuit
653 Antenna
655 Core Network (CN) interface
657 Controller
659 Memory
661 Operating system
663 Communications control module
668 N2 module
669 N3 module
672 RAN control module
673 UE profile management module
751 Transceiver circuit
752 gNB-CU interface
753 Non-RT RIC interface
757 Controller
759 Memory
761 Operating system
763 Communications control module
769 A1 module
770 E2 module
772 Near-RT RIC management module
773 UE profile management module
851 Transceiver circuit
853 Near-RT RIC interface
857 Controller
859 Memory
861 Operating system
863 Communications control module
869 A1 module
872 Non-RT RIC management module
873 UE profile management module
951 Transceiver circuit
954 Corresponding (network) interface
957 Controller
959 Memory
961 Operating system
963 Communications control module
965 Interface protocol module
972 Network node management module
973 UE profile management module

What is claimed is:

1. A method performed by a first network entity the method comprising:
obtaining information relating to a mobility state of a user equipment (UE) based on historical data of the UE;
determining a mobility specific configuration for the UE based on the mobility state; and
providing configuration information for configuring the UE with the mobility specific configuration.

2. The method according to claim 1, further comprising:
performing a verification of the information relating to the mobility state of the UE before determining the mobility specific configuration, wherein
the determining is performed in a case where the verification is successful.

3. The method according to claim 2, wherein the performing the verification is performed based on a comparison of, of a predicted location and/or predicted movement of the UE with location information and/or measurement data for the UE collected from the UE.

4. The method according to claim 2, wherein the performing the verification is performed based on a comparison of the information relating to the mobility state of the UE with another information relating to a mobility state of the UE generated by the first network entity or another network entity.

5. The method according to claim 1, wherein
the information relating to the mobility state of the UE includes information identifying a current and/or predicted mobility state for the UE, and the determining is performed based on the current and/or predicted mobility state for the UE.

6. The method according to claim 1, wherein the information relating to the mobility state of the UE includes an indication for indicating whether or not the UE is stationary or near-stationary, and/or an indication for indicating one of a plurality of mobility categories into which movement of the UE has been categorised.

7. The method according to claim 1, wherein the information relating to the mobility state of the UE includes an indication for indicating a mobility related configuration preference.

8. The method according to claim 1, wherein the information relating to the mobility state of the UE is included in at least one of:
a radio resource control (RRC) message;
a UE Assistance Information Message;
a media access control (MAC) control element (CE) message; and
a Non-Access Stratum (NAS) message.

9. The method according to claim 1, wherein the mobility specific configuration for the UE includes one of, or a combination of, the following:
a mobility specific measurement configuration;
a mobility specific power control (PC) configuration;
a mobility specific power headroom reporting (PHR) configuration;
a mobility specific time alignment timer (TAT) configuration; and/or
a mobility specific paging area/tracking area configuration.

10. The method according to claim 1, wherein the providing the configuration information is performed using one of:
a radio resource control (RRC) signalling; and
an RRC reconfiguration message.

11. The method according to claim 1, wherein the information relating to the mobility state of the UE is included in a UE profile.

12. The method according to claim 1, wherein
the obtaining includes receiving, from a second network entity, the information relating to the mobility state of the UE, and
the providing includes providing the configuration information, to the UE or to a third network entity.

13. The method according to claim 1, wherein
the obtaining includes receiving, from the UE, the information relating to the mobility state of the UE, and
the providing includes providing the configuration information, to the UE or to a second network entity.

14.-19. (canceled)

20. A method performed by a user equipment (UE), the method comprising:
providing, to a network entity, information relating to a mobility state of the UE to support determining a mobility specific configuration for the UE.

21. The method according to claim 20, further comprising:
receiving, from the network entity or another network entity, configuration information for configuring the UE with the mobility specific configuration.

22. The method according to claim 1, wherein the information relating to the mobility state of the UE includes information identifying a device type of the UE corresponding to the mobility status of the UE.

23. (canceled)

24. The method according to claim 1, wherein the information relating to the mobility state of the UE includes any one of, or combination of, the following:
information identifying a time at, or time period within, which the UE is expected to be stationary;
information identifying a location in which the UE is expected to be stationary;
information identifying a time at, or time period within, which the UE is expected to be moving;
information identifying a location to which, or from which, the UE is expected to be moving;
information identifying a geographic area within which movement of the UE is expected to be confined; and/or
information identifying a reliability of information in the information relating to the mobility state of the UE.

25. The method according to claim 24, wherein
the information relating to the mobility state of the UE includes information identifying a reliability of information in the information relating to the mobility state of the UE, and
the determining is performed based on the reliability.

26. A first network entity comprising:
a memory storing instructions; and
at least one processor configured to process the instructions to:
obtain information relating to a mobility state of a user equipment (UE);
determine a mobility specific configuration for the UE based on the mobility state; and
provide configuration information for configuring the UE with the mobility specific configuration.

27. A user equipment (UE) comprising:
a memory storing instructions; and
at least one processor configured to process the instructions to:
provide, to a network entity, information relating to a mobility state of the UE to support determining a mobility specific configuration for the UE.
